(19) United States
(12) Patent Application Publication
(10) Pub. No.: US 2023/0199681 A1
(43) Pub. Date: Jun. 22, 2023

(54) METHOD AND APPARATUS FOR INITIAL BEAM ALIGNMENT IN WIRELESS COMMUNICATION SYSTEM

(71) Applicant: LG ELECTRONICS INC., Seoul (KR)

(72) Inventor: Bong Jun HWANG, Seoul (KR)

(21) Appl. No.: 17/923,350

(22) PCT Filed: May 7, 2021
(86) PCT No.: PCT/KR2021/005700

§ 371 Date: Nov. 4, 2022

(30) Foreign Application Priority Data
May 8, 2020 (KR) 10-2020-0055328
Aug. 6, 2020 (KR) 10-2020-0098723

(51) Int. Cl. H04W 56/00; H04W 16/28; H04L 5/00

(52) U.S. Cl. CPC H04W 56/0015; H04W 16/28; H04L 5/0053

(57) ABSTRACT

The present disclosure relates to initial beam alignment in a wireless communication system. A method of operating a first terminal in a wireless communication system may comprise transmitting at least one synchronization signal and first messages using at least one transmit beam, receiving, from a second terminal, which has received a first message of the first messages, an ACK of acknowledges (ACKs) transmitted through a resource associated with the first message, and transmitting a second message comprising information related to the ACK using a first transmit beam used to transmit the first message.

### TECHNICAL FIELD

The present disclosure relates to a wireless communication system and, more particularly, to a method and device for initial beam alignment in a wireless communication system.

### BACKGROUND

A wireless communication system is a multiple access system that supports communication of multiple users by sharing available system resources (e.g., a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (mMTC), Ultra-Reliable and Low Latency Communication (URLLC), and so on, may be referred to as a new radio access technology (RAT) or new radio (NR). Herein, the NR may also support vehicle-to-everything (V2X) communication.

### SUMMARY

The present disclosure relates to a method and device for

The technical objects to be achieved in the present disclosure are not limited to the above-mentioned technical objects, and other technical objects that are not mentioned may be considered by those skilled in the art through the embodiments described below.

As an example of the present disclosure, a method of operating a first terminal in a wireless communication system may comprise transmitting at least one synchronization signal and first messages using at least one transmit beam, receiving, from a second terminal, which has received a first message of the first messages, an ACK of acknowledges (ACKs) transmitted through a resource associated with the first message, and transmitting a second message comprising information related to the ACK using a first transmit beam used to transmit the first message.

As an example of the present disclosure, a method of operating a second terminal in a wireless communication system may comprise receiving a synchronization signal transmitted by a first terminal using a first transmit beam which is one of a plurality of transmit beams, receiving a first message transmitted using the first transmit beam, transmitting acknowledges (ACKs) responsive to the first message using a plurality of transmit beams through a resource associated with the first message, and receiving a second message comprising information related to an ACK of the ACKs.

As an example of the present disclosure, a first terminal in a wireless communication system may comprise a transceiver and a processor coupled to the transceiver. The processor may perform configured to transmit at least one synchronization signal and first messages using at least one transmit beam, to receive, from a second terminal, which has received a first message of the first messages, an ACK of acknowledges (ACKs) transmitted through a resource associated with the first message and to transmit a second message comprising information related to the ACK using a first transmit beam used to transmit the first message.

As an example of the present disclosure, a second terminal in a wireless communication system may comprise a transceiver and a processor coupled to the transceiver. The processor may perform configured to receive a synchronization signal transmitted by a first terminal using a first transmit beam which is one of a plurality of transmit beams, to receive a first message transmitted using the first transmit beam, to transmit acknowledges (ACKs) responsive to the first message using a plurality of transmit beams through a resource associated with the first message and to receive a second message comprising information related to an ACK of the ACKs.

As an example of the present disclosure, an apparatus may comprise at least one memory and at least one processor functionally coupled to the at least one memory. The at least one processor may control the device to transmit at least one synchronization signal and first messages using at least one transmit beam, receive, from another device, which has received a first message of the first messages, an ACK of acknowledges (ACKs) transmitted through a resource associated with the first message, and transmit a second message comprising information related to the ACK using a first transmit beam used to transmit the first message.

As an example of the present disclosure, a non-transitory computer-readable medium storing at least one instruction may comprise the at least one instruction executable by a processor. The at least one instruction may instruct a device to transmit at least one synchronization signal and first messages using at least one transmit beam, receive, from another device, which has received a first message of the first messages, an ACK of acknowledges (ACKs) transmitted through a resource associated with the first message, and transmit a second message comprising information related to the ACK using a first transmit beam used to transmit the first message.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, beam alignment between two devices performing sidelink communication may be efficiently performed.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates a structure of a wireless communication system, in accordance with an embodiment of the present disclosure.

FIG. 2 illustrates a functional division between an NG-RAN and a SGC, in accordance with an embodiment of the present disclosure.

FIG. 3 illustrates a radio protocol architecture, in accordance with an embodiment of the present disclosure.

FIG. 4 illustrates a structure of a radio frame in an NR system, in accordance with an embodiment of the present disclosure.

FIG. 5 illustrates a structure of a slot in an NR frame, in accordance with an embodiment of the present disclosure.

FIG. 6 illustrates an example of a BWP, in accordance with an embodiment of the present disclosure.

FIGS. 7A and 7B illustrate a radio protocol architecture for a SL communication, in accordance with an embodiment of the present disclosure.

FIG. 8 illustrates a synchronization source or synchronization reference of V2X, in accordance with an embodiment of the present disclosure.

FIGS. 9A and 9B illustrate a procedure of performing V2X or SL communication by a terminal based on a transmission mode, in accordance with an embodiment of the present disclosure.

FIGS. 10A to 10C illustrate three cast types, in accordance with an embodiment of the present disclosure.

FIG. 11 illustrates the concept of initial beam alignment between terminals according to an embodiment of the present disclosure.

FIG. 12 illustrates an example of a method of operating a terminal starting a beam alignment procedure according to an embodiment of the present disclosure.

FIG. 13 illustrates an example of a method of operating a terminal participating in a beam alignment procedure according to an embodiment of the present disclosure.

FIGS. 14A to 14D illustrate an example of a procedure for transmit beam alignment between terminals according to an embodiment of the present disclosure.

FIG. 15 illustrates an example of a media access control (MAC) control element (CE) for delivering beam information according to an embodiment of the present disclosure.

FIG. 16 illustrates an example of a method of operating a terminal starting a transmit beam alignment procedure according to an embodiment of the present disclosure.

FIG. 17 illustrates an example of a method of operating a terminal participating in a transmit beam alignment procedure according to an embodiment of the present disclosure.

FIGS. 18A to 18D illustrate an example of a procedure for transmit/receive beam alignment between terminals according to an embodiment of the present disclosure.

FIG. 19 illustrates an example of a method of operating a terminal starting a transmit/receive beam alignment procedure according to an embodiment of the present disclosure.

FIG. 20 illustrates an example of a method of operating a terminal participating in a transmit/receive beam alignment procedure according to an embodiment of the present disclosure.

FIG. 21 illustrates a first example of signal exchange for transmit beam alignment between terminals according to an embodiment of the present disclosure.

FIG. 22 illustrates a second example of signal exchange for transmit beam alignment between terminals according to an embodiment of the present disclosure.

FIGS. 23A and 23B illustrate an example of signal exchange for transmit/receive beam alignment between terminals according to an embodiment of the present disclosure.

FIG. 24 illustrates a communication system, in accordance with an embodiment of the present disclosure.

FIG. 25 illustrates wireless devices, in accordance with an embodiment of the present disclosure.

FIG. 26 illustrates a signal process circuit for a transmission signal, in accordance with an embodiment of the present disclosure.

FIG. 27 illustrates a wireless device, in accordance with an embodiment of the present disclosure.

FIG. 28 illustrates a hand-held device, in accordance with an embodiment of the present disclosure.

FIG. 29 illustrates a car or an autonomous vehicle, in accordance with an embodiment of the present disclosure.

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present specification may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.

(1) 3GPP LTE
3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

(2) 3GPP NR (e.g. 5G)
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

Communication System Applicable to the Present Disclosure

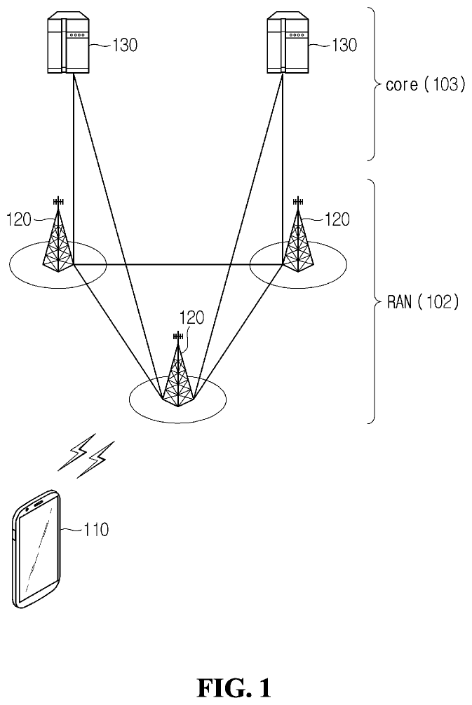

FIG. 1 illustrates a structure of a wireless communication system according to an embodiment of the present disclosure. The embodiment of FIG. 1 may be combined with various embodiments of the present disclosure.

Referring to FIG. 1, a wireless communication system includes a radio access network (RAN) 102 and a core network 103. The radio access network 102 includes a base station 120 that provides a control plane and a user plane to a terminal 110. The terminal 110 may be fixed or mobile, and may be called other terms such as a user equipment (UE), a mobile station (MS), a subscriber station (SS), a mobile subscriber station (MSS), a mobile terminal, an advanced mobile station (AMS), or a wireless device. The base station 120 refers to a node that provides a radio access service to the terminal 110, and may be called other terms such as a fixed station, a Node B, an eNB (eNode B), a gNB (gNode B), an ng-eNB, an advanced base station (ABS), an access point, a base transceiver system (BTS), or an access point (AP). The core network 103 includes a core network entity 130. The core network entity 130 may be defined in various ways according to functions, and may be called other terms such as a core network node, a network node, or a network equipment.

Components of a system may be referred to differently according to an applied system standard. In the case of the LTE or LTE-A standard, the radio access network 102 may be referred to as an Evolved-UMTS Terrestrial Radio Access Network (E-UTRAN), and the core network 103 may be referred to as an evolved packet core (EPC). In this case, the core network 103 includes a Mobility Management Entity (MME), a Serving Gateway (S-GW), and a packet data network-gateway (P-GW). The MME has access information of the terminal or information on the capability of the terminal, and this information is mainly used for mobility management of the terminal. The S-GW is a gateway having an E-UTRAN as an endpoint, and the P-GW is a gateway having a packet data network (PDN) as an endpoint.

In the case of the 5G NR standard, the radio access network 102 may be referred to as an NG-RAN, and the core network 103 may be referred to as a 5GC (5G core). In this case, the core network 103 includes an access and mobility management function (AMF), a user plane function (UPF), and a session management function (SMF). The AMF provides a function for access and mobility management in units of terminals, the UPF performs a function of mutually transmitting data units between an upper data network and the radio access network 102, and the SMF provides a session management function.

The BSs 120 may be connected to one another via Xn interface. The BS 120 may be connected to one another via core network 103 and NG interface. More specifically, the BSs 130 may be connected to an access and mobility management function (AMF) via NG-C interface, and may be connected to a user plane function (UPF) via NG-U interface.

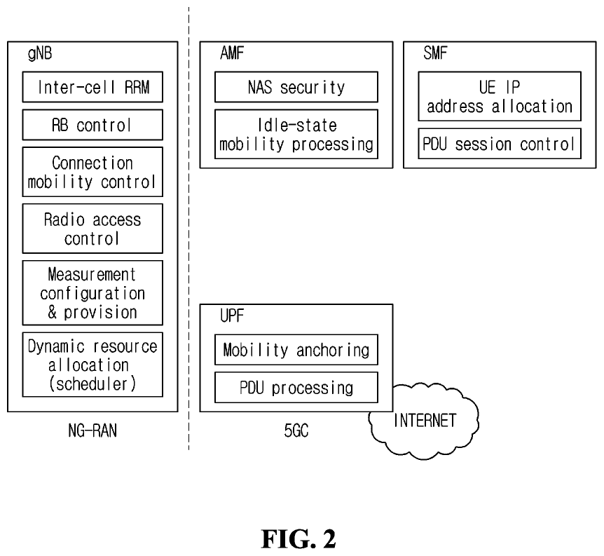

FIG. 2 illustrates a functional division between an NG-RAN and a 5GC, in accordance with an embodiment of the present disclosure. The embodiment of FIG. 2 may be combined with various embodiments of the present disclosure.

Referring to FIG. 2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer enable to exchange an RRC message between the UE and the BS.

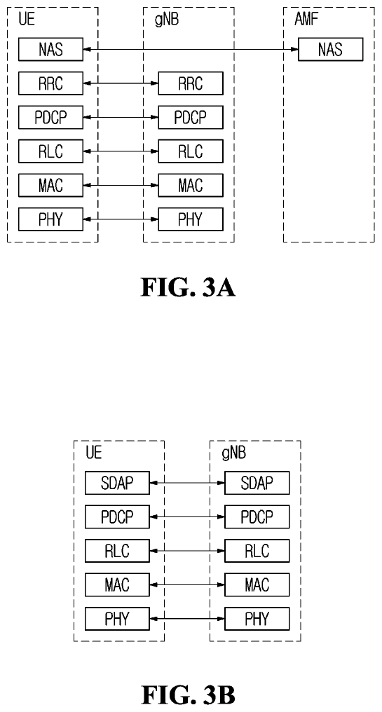

FIGS. 3A and 3B illustrate a radio protocol architecture, in accordance with an embodiment of the present disclosure. The embodiment of FIG. 3 may be combined with various embodiments of the present disclosure. Specifically, FIG. 3A exemplifies a radio protocol architecture for a user plane, and FIG. 3B exemplifies a radio protocol architecture for a control plane. The user plane corresponds to a protocol stack for user data transmission, and the control plane corresponds to a protocol stack for control signal transmission.

Referring to FIGS. 3A and 3B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PI-TY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Radio Resource Structure

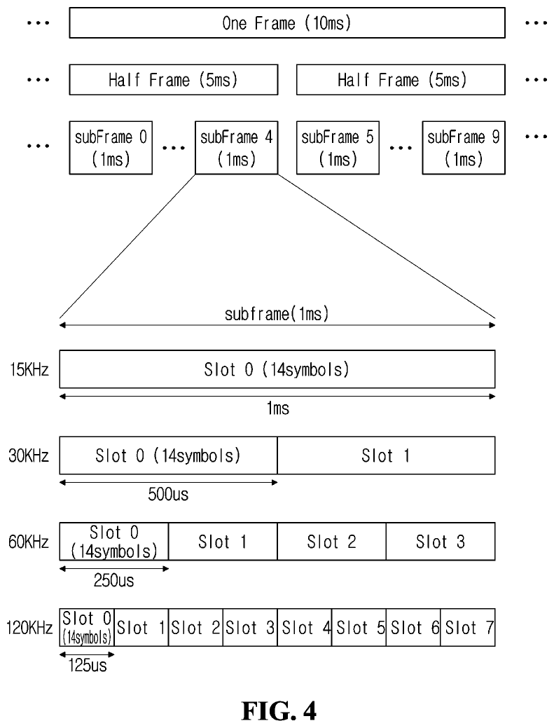

FIG. 4 illustrates a structure of a radio frame in an NR system, in accordance with an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

In a case where a normal CP is used, a number of symbols per slot (N^{slot}_{symb}), a number slots per frame (N^{frame,μ}ₛₗₒₜt), and a number of slots per subframe (N^{subframe,μ}ₛₗₒₜ) may be varied based on an SCS configuration (μ). For instance, SCS (=15*2^{μ}), N^{slot}_{symb}, N^{frame,μ}ₛₗₒₜ and N^{subframe,μ}ₛₗₒₜ are 15 KHz, 14, 10 and 1, respectively, when μ=0, are 30 KHz, 14, 20 and 2, respectively, when μ=1, are 60 KHz, 14, 40 and 4, respectively, when μ=2, are 120 KHz, 14, 80 and 8, respectively, when μ=3, or are 240 KHz, 14, 160 and 16, respectively, when μ=4. Meanwhile, in a case where an extended CP is used, SCS (=15*2^{μ}), N^{slot}_{symb}, N^{frame,μ} and N^{subframe,μ} are 60 KHz, 12, 40 and 2, respectively, when μ=2.

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells. In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

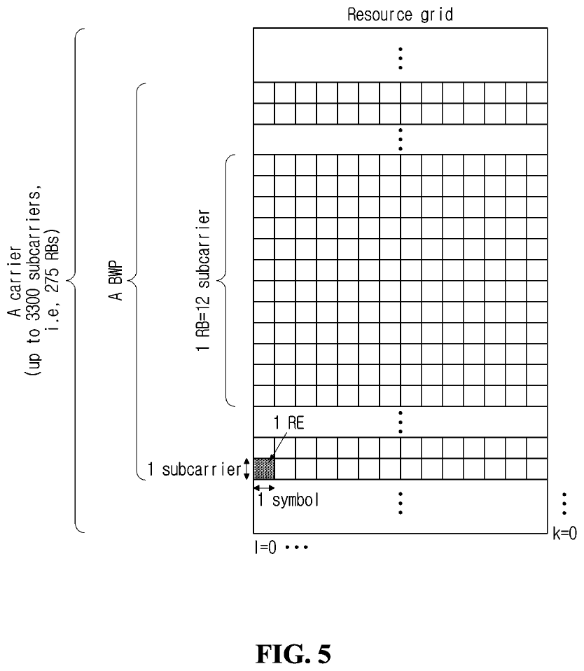

FIG. 5 illustrates a structure of a slot of an NR frame, in accordance with an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Bandwidth Part (BWP)

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit a Physical Uplink Control Channel (PUCCH) or a Physical Uplink Shared Channel (PUSCH) outside an active UL BWP. For example, in a downlink case, the initial BWP may be given as a consecutive RB set for a remaining minimum system information (RMSI) control resource set (CORESET) (configured by PBCH). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

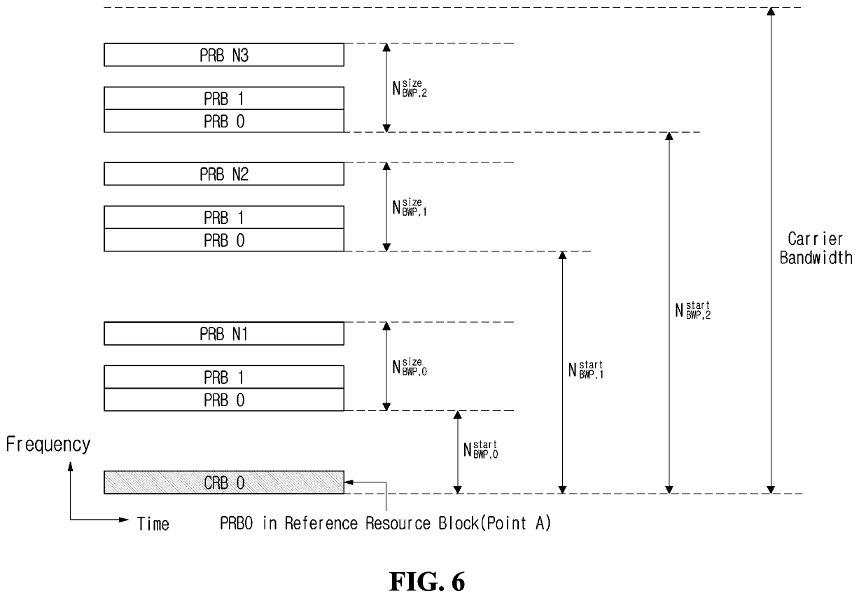

FIG. 6 illustrates an example of a BWP, in accordance with an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset (N^{start}_{BWP}) from the point A, and a bandwidth (N^{size}_{BWP}). For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

V2X or Sidelink Communication

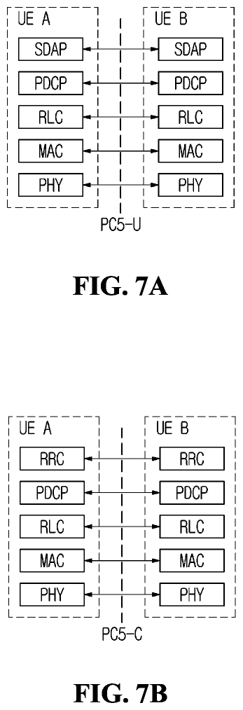

FIGS. 7A and 7B illustrate a radio protocol architecture for a SL communication, in accordance with an embodiment of the present disclosure. The embodiment of FIGS. 7A and 7B may be combined with various embodiments of the present disclosure. More specifically, FIG. 7A exemplifies a user plane protocol stack, and FIG. 7B exemplifies a control plane protocol stack.

Sidelink Synchronization Signal (SLSS) and Synchronization Information

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

For example, based on Table 1, the UE may generate an S-SS/PSBCH block (i.e., S-SSB), and the UE may transmit the S-SS/PSBCH block (i.e., S-SSB) by mapping it on a physical resource.

TABLE 1
▪ Time-frequency structure of an S-SS/PSBCH block
In the time domain, an S-SS/PSBCH block consists of N_{symb}^{S-SSB} OFDM symbols, numbered in
increasing order from 0 to N_{symb}^{S-SSB} − 1 within the S-SS/PSBCH block, where S-PSS, S-SSS,
and PSBCH with associated DM-RS are mapped to symbols as given by Table 8.4.3.1-1.
The number of OFDM symbols in an S-SS/PSBCH block N_{symb}^{S-SSB} = 13 for normal cyclic
prefix and N_{symb}^{S-SSB} = 11 for extended cyclic prefix. The first OFDM symbol in an S-
SS/PSBCH block is the first OFDM symbol in the slot.
In the frequency domain, an S-SS/PSBCH block consists of 132 contiguous subcarriers with
the subcarriers numbered in increasing order from 0 to 131 within the sidelink S-
SS/PSBCH block. The quantities k and l represent the frequency and time indices,
respectively, within one sidelink S-SS/PSBCH block.
For an S-SS/PSBCH block, the UE shall use

| | |
|---|---|
| - | antenna port 4000 for transmission of S-PSS, S-SSS, PSBCH and DM-RS for PSBCH; |
| - | the same cyclic prefix length and subcarrier spacing for the S-PSS, S-SSS, PSBCH |
| | and DM-RS for PSBCH. |

Table 8.4.3.1-1: Resources within an S-SS/PSBCH
block for S-PSS, S-SSS, PSBCH, and DM-RS.

| | OFDM symbol number l | Subcarrier number k |
|---|---|---|
| | relative to the start of | relative to the start of |
| Channel or signal | an S-SS/PSBCH block | an S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 131 |
| DM-RS for PSBCH | 0, 5, 6, . . . , N_{symb}^{S-SSB} − 1 | 0, 4, 8, . . . , 128 |

Synchronization Acquisition of SL Terminal

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

Synchronization acquisition of an SL UE will be described below.

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

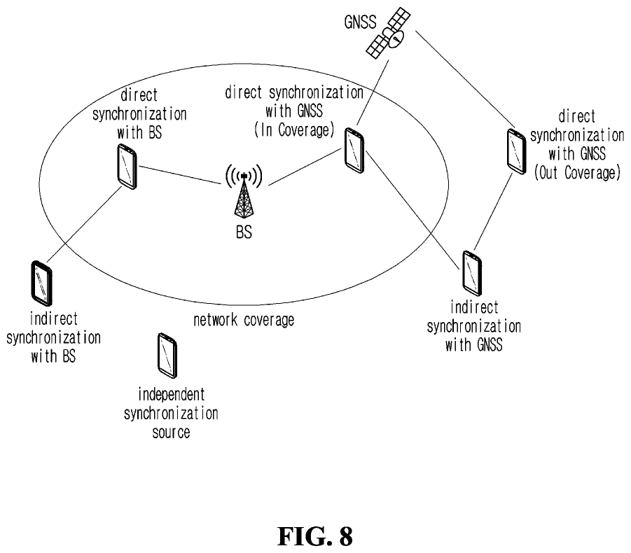

FIG. 8 illustrates a synchronization source or synchronization reference of V2X, in accordance with an embodiment of the present disclosure. The embodiment of FIG. 8 may be combined with various embodiments of the present disclosure.

Referring to FIG. 8, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or SL communication. In this case, the UE may follow the synchronization configuration received from the BS. When the UE fails in detecting any cell in the carrier used for the V2X or SL communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

An SL synchronization source may be related to a synchronization priority. For example, the relationship between synchronization sources and synchronization priorities may be defined as shown in [Table 2] or [Table 3]. [Table 2] or [Table 3] is merely an example, and the relationship between synchronization sources and synchronization priorities may be defined in various manners.

TABLE 2

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with NB/gNB |
| P2 | All UEs synchronized | All UEs synchronized |
| | indirectly with GNSS | indirectly with eNB/gNB |
| P3 | All other UEs | GNSS |
| P4 | N/A | All UEs synchronized |
| | | directly with GNSS |
| P5 | N/A | All UEs synchronized |
| | | indirectly with GNSS |
| P6 | N/A | All other UEs |

TABLE 3

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with eNB/gNB |
| P2 | All UEs synchronized | All UEs synchronized |
| | indirectly with GNSS | indirectly with eNB/gNB |
| P3 | eNB/gNB | GNSS |
| P4 | All UEs synchronized | All UEs synchronized |
| | directly with eNB/gNB | directly with GNSS |
| P5 | All UEs synchronized | All UEs synchronized |
| | indirectly with eNB/gNB | indirectly with GNSS |
| P6 | Remaining UE(s) with | Remaining UE(s) with |
| | lower priority | lower priority |

In [Table 2] or [Table 3], P0 may represent a highest priority, and P6 may represent a lowest priority. In [Table 2] or [Table 3], the BS may include at least one of a gNB or an eNB.

Whether to use GNSS-based synchronization or eNB/gNB-based synchronization may be (pre)determined. In a single-carrier operation, the UE may derive its transmission timing from an available synchronization reference with the highest priority.

For example, the UE may (re)select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

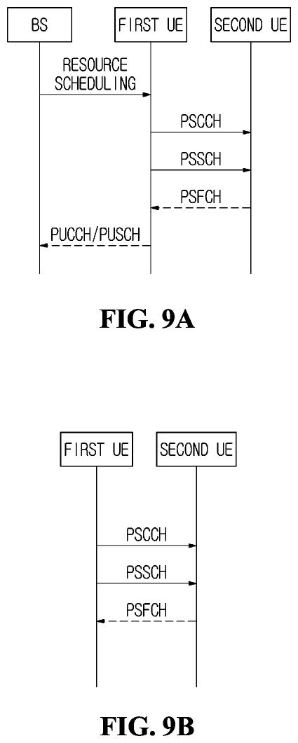

FIGS. 9A and 9B illustrate a procedure of performing V2X or SL communication by a terminal based on a transmission mode, in accordance with an embodiment of the present disclosure. The embodiment of FIGS. 9A and 9B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 9A exemplifies a UE operation related to an LTE transmission mode 1 or an LTE transmission mode 3. Alternatively, for example, FIG. 9B exemplifies a UE operation related to an NR resource allocation mode 1. For example, the LTE transmission mode 1 may be applied to general SL communication, and the LTE transmission mode 3 may be applied to V2X communication.

For example, FIG. 9B exemplifies a UE operation related to an LTE transmission mode 2 or an LTE transmission mode 4. Alternatively, for example, FIG. 9A exemplifies a UE operation related to an NR resource allocation mode 2.

Referring to FIG. 9A, in the LTE transmission mode 1, the LTE transmission mode 3, or the NR resource allocation mode 1, a BS may schedule an SL resource to be used by the UE for SL transmission. For example, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

Subsequently, the first UE may transmit a PSCCH (e.g., sidelink control information (SCI) or 1V-stage SCI) to a second UE based on the resource scheduling. After then, the first UE may transmit a PSSCH (e.g., 2^{nd}-stage SCI, MAC PDU, data, etc.) related to the PSCCH to the second UE. After then, the first UE may receive a PSFCH related to the PSCCH/PSSCH from the second UE. For example, HARQ feedback information (e.g., NACK information or ACK information) may be received from the second UE through the PSFCH. After then, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table 4 shows an example of a DCI for SL scheduling.

TABLE 4
3GPP TS 38.212

▪ Format 3_0
DCI format 3_0 is used for scheduling of NR PSCCH and NR PSSCH in one cell.
The following information is transmitted by means of the DCI format 3_0 with CRC scrambled
by SL-RNTI or SL-CS-RNTI:

| | - | Resource pool index -┌log₂ I┐ bits, where I is the number of resource pools for |
|---|---|---|
| | | transmission configured by the higher layer parameter sl-TxPoolScheduling. |
| | - | Time gap - 3 bits determined by higher layer parameter sl-DCI-ToSL-Trans. as |
| | | defined in clause 8.1.2.1 of [6, TS 38.214] |
| | - | HARQ process number - 4 bits as defined in clause 16.4 of [5, TS 38.213] |
| | - | New data indicator - 1 bit as defined in clause 16.4 of [5, TS 38.213] |
| | - | Lowest index of the subchannel allocation to the initial transmission -┌log₂(N_{subChannel}^{SL})┐ |
| | | bits as defined in clause 8.1.2.2 of [6, TS 38.214] |
| - | SCI format 1-A fields according to clause 8.3.1.1: | |
| | - | Frequency resource assignment. |
| | - | Time resource assignment. |
| - | PSFCH-to-HARQ feedback timing indicator -┌log₂ N_{fb}_timing┐ bits, where N_{fb}_timing is th [symbol] | |
| | number of entries in the higher layer parameter sl-PSFCH-ToPUCCH, as defined i [symbol] | |
| | clause 16.5 of [5, TS 38.213] | |
| - | PUCCH resource indicator - 3 bits as defined in clause 16.5 of [5, TS 38.213]. | |
| - | Configuration index - 0 bit if the UE is not configured to monitor DCI format 3_0 wit [symbol] | |
| | CRC scrambled by SL-CS-RNTI: otherwise 3 bits as defined in clause 8.1.2 of [6, T [symbol] | |
| | 38.214]. If the UE is configured to monitor DCI format 3_0 with CRC scrambled by SL- [symbol] | |
| | CS-RNTI, this field is reserved for DCI format 3_0 with CRC scrambled by SL-RNTI. | |
| - | Counter sidelink assignment index - 2 bits | |
| | - | 2 bits as defined in clause 16.5.2 of [5, TS 38.213] if the UE is configured wit [symbol] |
| | | pdsch-HARQ-ACK-Codebook = dynamic |
| | - | 2 bits as defined in clause 16.5.1 of [5, TS 38.213] if the UE is configured wit [symbol] |
| | | pdsch-HARQ-ACK-Codebook = semi-static |

| | |
|---|---|
| - | Padding bits, if required |

▪ Format 3_1
DCI format 3_1 is used for scheduling of LTE PSCCH and LTE PSSCH in one cell.
The following information is transmitted by means of the DCI format 3_1 with CRC scramb [symbol]
by SL-L-CS-RNTI:

| - | Timing offset - 3 bits determined by higher layer parameter sl-TimeOffsetEUTRA, [symbol] | |
|---|---|---|
| | defined in clause 16.6 of [5, TS 38.213] | |
| - | Carrier indicator -3 bits as defined in 5.3.3.1.9A of [11, TS 36.212]. | |
| - | Lowest index of the subchannel allocation to the initial transmission - ┌log₂(N_{subchannel}^{SL} [symbol] | |
| | bits as defined in 5.3.3.1.9A of [11, TS 36.212]. | |
| - | Frequency resource location of initial transmission and retransmission, as define [symbol] | |
| | 5.3.3.1.9A of [11, TS 36.212] | |
| - | Time gap between initial transmission and retransmission, as defined in 5.3.3.1.9A [symbol] | |
| | [11, TS 36.212] | |
| - | SL index - 2 bits as defined in 5.3.3.1.9A of [11, TS 36.212] | |
| - | SL SPS configuration index - 3 bits as defined in clause 5.3.3.1.9A of [11, TS 36.21 [symbol] | |
| - | | Activation/release indication - 1 bit as defined in clause 5.3.3.1.9A of [11, [symbol] |

36.212]. [symbol]
indicates data missing or illegible when filed

Referring to FIG. 9B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannel(s). For example, subsequently, a first UE which has selected resource(s) from a resource pool by itself may transmit a PSCCH (e.g., sidelink control information (SCI) or 1V-stage SCI) to a second UE by using the resource(s). After then, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIGS. 9A and 9B, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A, and the 2^{nd}-stage SCI format may include a SCI format 2-A and/or a SCI format 2-B. Table 5 shows an example of a 1^{st}-stage SCI format.

```
TABLE 5
3GPP TS 38.212
▪ SCI format 1-A
SCI format 1-A is used for the scheduling of PSSCH and 2^{nd}-stage-SCI on PSSCH
The following information is transmitted by means of the SCI format 1-A
  - Priority - 3 bits as specified in clause 5.4.3.3 of [12, TS 23.287] and clause 5.22.1.3.1
    of [8, TS 38.321]
```

| | | |
|---|---|---|
| - Frequency resource assignment - | $⌈ {log}_{2} ( \frac{{N}_{subChannel}^{SL} ( {N}_{subChannel}^{SL} + 1 )}{2} ) ⌉$ | bits when the vahue or |

the higher layer parameter sl-MaxNumPerReserve is configured to 2; otherwise

| | |
|---|---|
| $⌈ {log}_{2} ( \frac{{N}_{subChannel}^{SL} ( {N}_{subchannel}^{SL} + 1 ) ( 2 {N}_{subChannel}^{SL} + 1 )}{6} ) ⌉$ | bits when the value of the higher layer |

```
    parameter sl-NaxNumPerReserve is configured to 3, as defined in clause 8.1.2.2 of ┌6,
    TS 38.214┐.
  - Time resource assignment - 5 bits when the value of the higher layer parameter sl-
    MaxNumPerReserve is configured to 2; otherwise 9 bits when the value of the higher
    layer parameter sl-MaxNurnPerReserve is configured to 3, as defined in clause 8.1.2.1
    of [6, TS 38.214].
  - Resource reservation period -┌log₂ Nᵣₑᵥ_period┐ bits as defined in clause 8.1.4 of └6, TS
    38.214┘, where Nᵣₑᵥ_period is the number of entries in the higher layer parameter sl-
    ResourceReservePeriodList, if higher layer parameter sl-MultiReserveResource is
    configured; 0 bit otherwise.
  - DMRS pattern - ┌log₂ Nₚₐₜₜₑᵣₙ┐ bits as defined in clause 8.4.1.1.2 of [4, TS 38.211],
    where Nₚₐₜₜₑᵣₙ is the number of DMRS patterns configured by higher layer parameter
    sl-PSSCH-DMRS-TimePatternList.
  - 2^{nd}-stage SCI format - 2 bits as defined in Table 8.3.1.1-1.
  - Beta_offset indicator - 2 bits as provided by higher layer parameter sl-
    BetaOffsets2ndSCI and Table 8.3.1.1-2.
  - Number of DMRS port - 1 bit as defined in Table 8.3.1.1-3.
  - Modulation and coding scheme - 5 bits as defined in clause 8.1.3 of [6, TS 38.214].
  - Additional MCS table indicator - as defined in clause 8.1.3.1 of [6, TS 38 214]: 1 bit if
    one MCS table is configured by higher layer parameter sl-Additional-MCS-Table; 2
    bits if two MCS tables are configured by higher layer parameter sl- Additional-MCS-
    Table; 0 bit otherwise.
  - PSFCH overhead indication - 1 bit as defined clause 8.1.3.2 of └6, TS 38. 214┘ if higher
    layer parameter sl-PSFCH-Period = 2 or 4: 0 bit otherwise.
  - Reserved - a number of bits as determined by higher layer parameter sl-
    NumReservedBits, with value set to zero.
Table 8.3.1.1-1: 2^{nd} -stage SCI formats
```

| Value of 2nd-stage | |
|---|---|
| SCI format field | 2nd-stage SCI formal. |
| 00 | SCI format 2-A |
| 01 | SCI format 2-B |
| 10 | Reserved |
| 11 | Reserved |

Table 8.3.1.1-2: Mapping of Beta_offset indicator values to indexes in Table 9.3-2 of
[5, TS38.213]

| Value of Beta_offset | Beta_offset Index in Table 9.3-2 of |
|---|---|
| indicator | [5, TS38.213] |
| 00 | lst index provided by higher layer parameter |
| | sl-BetaOffsets2ndSCI |
| 01 | 2nd index provided by higher layer parameter |
| | sl-BetaOffsets2ndSCI |
| 10 | 3rd index provided by higher layer parameter |
| | sl-BetaOffsets2ndSCI |
| 11 | 4th index provided by higher layer parameter |
| | sl-BetaOffsets2ndSCI |

Table 6 shows an example of a 2^{nd}-stage SCI format.

TABLE 6
3GPP TS 38.212

▪ SCI format 2-A
SCI format 2-A is used for the decoding of PSSCH, with HARQ operation when HARQ-ACK
information includes ACK or NACK, when HARQ-ACK information includes only NACK, or
when there is no feedback of HARQ-ACK information.
The following information is transmitted by means of the SCI format 2-A:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Cast type indicator - 2 bits as defined, in Table 8.4.1.1-1. |
| - | CSI request - 1 bit as defined in clause 8.2.1 of [6, TS 38.214]. |

Table 8.4.1.1-1: Cast type indicator

| Value of Cast | |
|---|---|
| type indicator | Cast type |
| 00 | Broadcast |
| 01 | Groupcast when HARQ-ACK |
| | information includes ACK or NACK |
| 10 | Unicast |
| 11 | Groupcast when HARQ-ACK |
| | information includes only NACK |

▪ SCI format 2-B
SCI format 2-B is used for the decoding of PSSCH, with HARQ operation when HARQ-ACK
information includes only NACK, or when there is no feedback of HARQ-ACK information.
The following information is transmitted by means of the SCI format 2-B:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Zone ID - 12 bits as defined in clause 5.8.11 of [9, TS 38.331]. |

| | |
|---|---|
| - | Communication range requirement - 4 bits determined by higher layer parameter sl- |

ZoneConfigMCR-Index.

Referring to FIGS. 9A and 9B, the first UE may receive the PSFCH based on Table 7. For example, the first UE and the second UE may determine a PSFCH resource based on Table 7, and the second UE may transmit HARQ feedback to the first UE using the PSFCH resource.

TABLE 7
3GPP TS 38.213

▪ UE procedure for reporting HARQ-ACK on sidelink
A UE can be indicated by an SCI format scheduling a PSSCH reception, in one or more sub-
channels from a number of N_{subch}^{PSSCH} sub-channels, to transmit a PSFCH with HARQ-ACK
information in response to the PSSCH reception. The UE provides HARQ-ACK information
that includes ACK or NACK, or only NACK.
A UE can be provided, by sl-PSFCH-Period-r16, a number of slots in a resource pool for a
period of PSFCH transmission occasion resources. If the number is zero, PSFCH
transmissions from the UE in the resource pool are disabled.
A UE expects that a slot t′ₖ^{SL} (0 ≤ k < T′ₘₐₓ) has a PSFCH transmission occasion resource if
k mod N_{PSSCH}^{PSPCH} = 0, where t′ₖ^{SL} is defined in [6, TS 38.214], and T′ₘₐₓ is a number of slots that
belong to the resource pool within 10240 msec according to [6, TS 38.214], and N_{PSSCH}^{PSFCH} is
provided by sl-PSFCH-Period-r16.
A UE may be indicated by higher layers to not transmit a PSFCH in response to a PSSCH
reception [11, TS 38.321].
If a UE receives a PSSCH in a resource pool and the HARQ feedback enabled/disabled
indicator field in an associated SCI format 2-A or a SCI format 2-B has value 1 [5, TS
38.212], the UE provides the HARQ-ACK information in a PSFCH transmission in the
resource pool. The UE transmits the PSFCH in a first slot that includes PSFCH resources
and is at least a number of slots, provided by sl-MinTimeGapPSFCH-r16, of the resource
pool after a last slot of the PSSCH reception.
A UE is provided by sl-PSFCH-RB-Set-r16 a set of M_{PRB, set}^{PSFCH} PRBs in a resource pool for
PSFCH transmission in a PRB of the resource pool. For a number of N_{subch} sub-channels for
the resource pool, provided by sl-NumSubchannel, and a number of PSSCH slots associated
with a PSFCH slot that is less than or equal to N_{PSSCH}^{PSFCH}, the UE allocates the
[(i + j · N_{PSSCH}^{PSFCH}) · M_{subch, slot}^{PSFCH}, (i + 1 + j · N_{PSSCH}^{PSFCH}) · M_{subch, slot}^{PSFCH} − 1] PRBs from the M_{PRB, set}^{PSFCH} PRBs to
slot i among the PSSCH slots associated with the PSFCH slot and sub-channel j, where
M_{subch, slot}^{PSFCH} = M_{PRB, set}^{PSFCH}/(N_{subch} · N_{PSSCH}^{PSFCH}), 0 ≤ i < N_{PSSCH}^{PSFCH}, 0 ≤ j < N_{subch}, and the allocation starts
in an ascending order of i and continues in an ascending order of j. The UE expects that
M_{PRB, set}^{PSFCH} is a multiple of N_{subch} · N_{PSSCH}^{PSFCH}.
A UE determines a number of PSFCH resources available for multiplexing HARQ-ACK
information in a PSFCH transmission as R_{PRB, CS}^{PSFCH} = N_{type}^{PSFCH} · M_{subch, slot}^{PSFCH} · N_{CS}^{PSFCH} where N_{CS}^{PSFCH}
is a number of cyclic shift pairs for the resource pool and, based on an indication by higher
layers.

| | |
|---|---|
| - | N_{type}^{PSFCH} = 1 and the M_{subch, slot}^{PSFCH} PRBs are associated with the starting sub-channel of the |
| | corresponding PSSCH |
| - | N_{type}^{PSFCH} = N_{subch}^{PSSCH} and the N_{subch}^{PSSCH} · M_{subch, slot}^{PSFCH} PRBs are associated with one or more |
| | sub-channels from the N_{subch}^{PSSCH} sub-channels of the corresponding PSSCH |

The PSFCH resources are first indexed according to an ascending order of the PRB index,
from the N_{type}^{PSFCH} · M_{subch, slot}^{PSFCH} PRBs, and then according to an ascending order of the cyclic
shift pair index from the N_{CS}^{PSFCH} cyclic shift pairs.
A UE determines an index of a PSFCH resource for a PSFCH transmission in response to a
PSSCH reception as (P_{ID} + M_{ID})modR_{PRB, CS}^{PSFCH} where P_{ID} is a physical layer source ID provided
by SCI format 2-A or 2-B [5, TS 38.212] scheduling the PSSCH reception, and M_{ID} is the
identity of the UE receiving the PSSCH as indicated by higher layers if the UE detects a SCI
formal 2-A with Cast type indicator field value of “01”; otherwise, M_{ID} is zero.
A UE determines a m₀ value, for computing a value of cyclic shift α [4, TS 38.211], from a
cyclic shift pair index corresponding to a PSFCH resource index and from N_{CS}^{PSFCH} using
Table 16.3-1.
Table 16.3-1: Set of cyclic shift pairs

m₀

| | Cyclic | Cyclic | Cyclic | Cyclic | Cyclic | Cyclic |
|---|---|---|---|---|---|---|
| | Shift Pair | Shift Pair | Shift Pair | Shift Pair | Shift Pair | Shift Pair |
| N_{CS}^{PSFCH} | Index 0 | Index 1 | Index 2 | Index 3 | Index 4 | Index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{cs} value, for computing a value of cyclic shift α [4, TS 38.211], as in
Table 16.3-2 if the UE detects a SCI format 2-A with Cast type indicator field value of “01”
or “10”, or as in Table 16.3-3 if the UE detects a SCI format 2-B or a SCI format 2-A with
Cast type indicator field value of “11”. The UE applies one cyclic shift from a cyclic shift pair
to a sequence used for the PSFCH transmission [4, TS 38.211].
Table 16.3-2: Mapping of HARQ-ACK information bit values to a cyclic shift, from a cyclic shift
pair, of a sequence for a PSFCH transmission when HARQ-ACK information includes ACK or NACK

| HARQ-ACK Value | 0 (NACK) | 1 (ACK) |
|---|---|---|
| Sequence cyclic shift | 0 | 6 |

Table 16.3-3: Mapping of HARQ-ACK information bit values to a cyclic shift, from a cyclic shift
pair, of a sequence for a PSFCH transmission when HARQ-ACK information includes only NACK

| HARQ-ACK Value | 0 (NACK) | 1 (ACK) |
|---|---|---|
| Sequence cyclic shift | 0 | N/A |

Referring to FIG. 9A, the first UE may transmit SL HARQ feedback to the base station through the PUCCH and/or the PUSCH based on Table 8.

TABLE 8
3GPP TS 38.213

16.5 UE procedure for reporting HARQ-ACK on uplink
A UE can be provided PUCCH resources or PUSCH resources [12, TS 38.331] to report
HARQ-ACK information that the UE generates based on HARQ-ACK information that the UE
obtains from PSFCH receptions, or from absence of PSFCH receptions. The UE reports
HARQ-ACK information on the primary cell of the PUCCH group, as described in Clause 9,
of the cell where the UE monitors PDCCH for detection of DCI format 3_0.
For SL configured grant Type 1 or Type 2 PSSCH transmissions by a UE within a time period
provided by sl-PeriodCG, the UE generates one HARQ-ACK information bit in response to
the PSFCH receptions to multiplex in a PUCCH transmission occasion that is after a last time
resource, in a set of time resources.
For PSSCH transmissions scheduled by a DCI format 3_0, a UE generates HARQ-ACK
information in response to PSFCH receptions to multiplex in a PUCCH transmission occasion
that is after a last time resource in a set of time resources provided by the DCI format 3_0.
For each PSFCH reception occasion, from a number of PSFCH reception occasions, the UE
generates HARQ-ACK information to report in a PUCCH or PUSCH transmission. The UE
can be indicated by a SCI format to perform one of the following and the UE constructs a
HARQ-ACK codeword with HARQ-ACK information, when applicable

| - | if the UE receives a PSFCH associated with a SCI format 2-A with Cast type indicator | |
|---|---|---|
| | field value of “10” | |
| | - | generate HARQ-ACK information with same value as a value of HARQ-ACK |
| | | information the UE determines from a PSFCH reception in the PSFCH reception |
| | | occasion and, if the UE determines that a PSFCH is not received at the PSFCH |
| | | reception occasion, generate NACK |
| - | if the UE receives a PSFCH associated with a SCI format 2-A with Cast type indicator | |
| | field value of “01” | |
| | - | generate ACK if the UE determines ACK from at least one PSFCH reception |
| | | occasion, from the number of PSFCH reception occasions, in PSFCH resources |
| | | corresponding to every identity M_{ID} of the UEs that the UE expects to receive the |
| | | PSSCH, as described in Clause 16.3; otherwise, generate NACK |
| - | if the UE receives a PSFCH associated with a SCI format 2-B or a SCI format 2-A with | |
| | Cast type indicator field value of “11” | |
| | - | generate ACK when the UE determines absence of PSFCH reception for each |
| | | PSFCH reception occasion from the number of PSFCH reception occasions: |
| | | otherwise, generate NACK |

After a UE transmits PSSCHs and receives PSFCHs in corresponding PSFCH resource
occasions, the priority value of HARQ-ACK information is same as the priority value of the
PSSCH transmissions that is associated with the PSFCH reception occasions providing the
HARQ-ACK information.
The UE generates a NACK when, due to prioritization, as described in Clause 16.2.4, the UE
does not receive PSFCH in any PSFCH reception occasion associated with a PSSCH
transmission in a resource provided by a DCI format 3_0 with CRC scrambled by a SL-RNTI
or, for a configured grant, in a resource provided in a single period and for which the UE is
provided a PUCCH resource to report HARQ-ACK information. The priority value of the
NACK is same as the priority value of the PSSCH transmission.
The UE generates a NACK when, due to prioritization as described in Clause 16.2.4, the UE
does not transmit a PSSCH in any of the resources provided by a DCI format 3_0 with CRC
scrambled by SL-RNTI or, for a configured grant, in any of the resources provided in a single
period and for which the UE is provided a PUCCH resource to report HARQ-ACK information.
The priority value of the NACK is same as the priority value of the PSSCH that was not
transmitted due to prioritization.
The UE generates an ACK if the UE does not transmit a PSCCH with a SCI format 1-A
scheduling a PSSCH in any of the resources provided by a configured grant in a single period
and for which the UE is provided a PUCCH resource to report HARQ-ACK information. The
priority value of the ACK is same as the largest priority value among the possible priority
values for the configured grant.
A UE does not expect to be provided PUCCH resources or PUSCH resources to report
HARQ-ACK information that start earlier than (N + 1) · (2048 + 144) · κ · 2^{μ} · T_{c} after the end
of a last symbol of a last PSFCH reception occasion, from a number of PSFCH reception
occasions that the UE generates HARQ-ACK information to report in a PUCCH or PUSCH
transmission, where

| | |
|---|---|
| - | κ and T_{c} are defined in [4, TS 38.211] |
| - | μ = min (μ_{SL}, μ_{UL}), where μ_{SL} is the SCS configuration of the SL BWP and μ_{UL} is the SCS |
| | configuration of the active UL BWP on the primary cell |
| - | N is determined from μ according to Table 16.5-1 |

Table 16.5-1: Values of N

| μ | N |
|---|---|
| 0 | 14 |
| 1 | 18 |
| 2 | 28 |
| 3 | 32 |

With reference to slots for PUCCH transmissions and for a number of PSFCH reception
occasions ending in slot n, the UE provides the generated HARQ-ACK information in a
PUCCH transmission within slot n + k, subject to the overlapping conditions in Clause 9.2.5,
where k is a number of slots indicated by a PSFCH-to-HARQ_feedback timing indicator
field, if present, in a DCI format indicating a slot for PUCCH transmission to report the HARQ-
ACK information, or k is provided by sl-PSFCH-ToPUCCH-CG-Type1-r16. k = 0
corresponds to a last slot for a PUCCH transmission that would overlap with the last PSFCH
reception occasion assuming that the start of the sidelink frame is same as the start of the
downlink frame [4, TS 38.211].
For a PSSCH transmission by a UE that is scheduled by a DCI format, or for a SL configured
grant Type 2 PSSCH transmission activated by a DCI format, the DCI format indicates to the
UE that a PUCCH resource is not provided when a value of the PUCCH resource indicator
field is zero and a value of PSFCH-to-HARQ feedback timing indicator field, if present, is
zero. For a SL configured grant Type 1 PSSCH transmission, a PUCCH resource can be
provided by sl-N1PUCCH-AN-r16 and sl-PSFCH-ToPUCCH-CG-Type1-r16. If a PUCCH
resource is not provided, the UE does not transmit a PUCCH with generated HARQ-ACK
information from PSFCH reception occasions.
For a PUCCH transmission with HARQ-ACK information, a UE determines a PUCCH resource
after determining a set of PUCCH resources for O_{UCI} HARQ-ACK information bits, as
described in Clause 9.2.1. The PUCCH resource determination is based on a PUCCH resource
indicator field [5, TS 38.212] in a last DCI format 3_0, among the DCI formats 3_0 that have
a value of a PSFCH-to-HARQ_feedback timing indicator field indicating a same slot for the
PUCCH transmission, that the UE detects and for which the UE transmits corresponding
HARQ-ACK information in the PUCCH where, for PUCCH resource determination, detected
DCI formats are indexed in an ascending order across PDCCH monitoring occasion indexes.
A UE does not expect to multiplex HARQ-ACK information for more than one SL configured
grants in a same PUCCH.
A priority value of a PUCCH transmission with one or more sidelink HARQ-ACK information
bits is the smallest priority value for the one or more HARQ-ACK information bits.
In the following, the CRC for DCI format 3_0 is scrambled with a SL-RNTI or a SL-CS-RNTI.

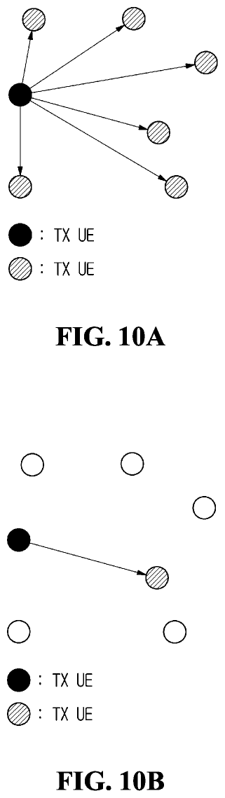

FIGS. 10A to 10C illustrate three cast types applicable to the present disclosure. The embodiment of FIGS. 10A to 10C may be combined with various embodiments of the present disclosure.

Specifically, FIG. 10A exemplifies broadcast-type SL communication, FIG. 10B exemplifies unicast type-SL communication, and FIG. 10C exemplifies groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

### Specific Embodiment of the Present Disclosure

The present disclosure relates to initial beam alignment, and more particularly, to a technology for performing initial beam alignment between terminals performing sidelink communication.

At the 3GPP meeting performing 5G standardization, 5G NR sidelink and NR V2X technologies are being discussed. 3GPP has defined a numerology for FR2 (Frequency Range 2), which is a millimeter wave (mmWave) communication frequency band, but does not refer to a standard technology for operating NR sidelink communication in the corresponding frequency domain. During millimeter wave V2X communication, in order to solve the problem of limited coverage due to propagation characteristics of a high frequency band, a beamforming technology using a directional antenna is expected to be used. When the beamforming technology is applied, in order to achieve communication between vehicles or terminals, a beam alignment technology is very important. In particular, NR sidelink supports both a unicast mode and a groupcast mode, and terminals operating in the corresponding mode require bidirectional transmit beamforming. Accordingly, there is a need for a method for supporting bidirectional transmit beamforming of all peer terminals participating in sidelink communication.

Beam alignment between a base station and a terminal may be performed using a RACH procedure for initial access. However, since there is no RACH procedure for sidelink communication, it is difficult to apply a method of using an SSB and a RACH defined in the current standard to initial beam alignment for sidelink communication. That is, a procedure for beam alignment between terminals currently performing sidelink communication has not been defined. Accordingly, the present disclosure proposes a technology for performing initial beam alignment between terminals for effective V2X communication between vehicles.

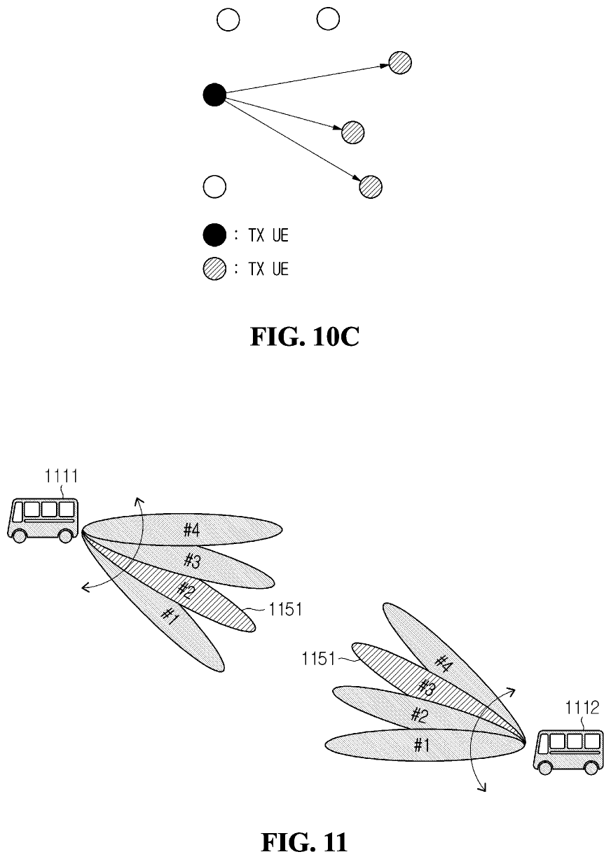

FIG. 11 illustrates the concept of initial beam alignment between terminals according to an embodiment of the present disclosure. FIG. 11 illustrates the concept of beam alignment between a first terminal 1111 and a second terminal 1112.

Referring to FIG. 11, the first terminal 1111 and the second terminal 1112 will perform sidelink communication. In this case, the first terminal 1111 transmits a synchronization signal (e.g., SLSS), and the second terminal 1112 receives the synchronization signal, so that the first terminal 1111 and the second terminal 1112 are mutually synchronized. At this time, as shown in FIG. 11, each of the first terminal 1111 and the second terminal 1112 has the ability to form beams in different directions. When a signal is transmitted from the first terminal 1111 to the second terminal 1112, the first terminal 1111 may perform transmit beamforming and the second terminal 1112 may perform receive beamforming. In FIG. 11, the beam widths of the transmit beam and the receive beam are the same, but the beam widths of the transmit beam and the receive beam may be different from each other.

In order to perform communication using a beamformed signal, a beam alignment operation of determining a pair of a transmit beam and a receive beam providing communication quality is required. For example, in the case of FIG. 11, since transmit beam #2 1151 among the transmit beams of the first terminal 1111 and receive beam #3 1152 among the receive beams of the second terminal 1112 are a pair of optimum beams, the first terminal 1111 and the second terminal 1112 will have to check the beam pair of transmit beam #2 1151 and receive beam #3 1152. If the receive beam is an omni-directional beam, the first terminal 1111 and the second terminal 1112 need to confirm transmit beam #2 1151. In this case, since communication is not always performed in one direction, beam alignment for one of the transmit beam of the second terminal 1112 and the receive beam of the first terminal 1111 may also be performed.

When determining the beam pair of transmission of the first terminal 1111 and reception of the second terminal 1112, the first terminal 1111 may beam-sweep the signal, and the second terminal 1112 may measure a beam-swept signal, select an optimum transmit beam, and feed it back to the first terminal 1111. To this end, it is necessary to define which signal is beam-swept and how a beam selection result is fed back. Accordingly, the present disclosure will describe various embodiments for beam alignment as follows.

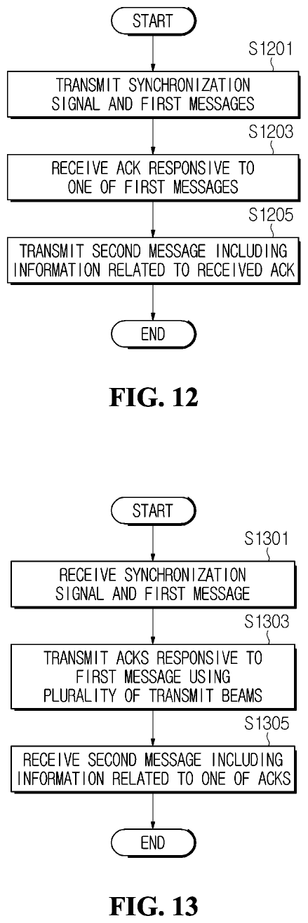

FIG. 12 illustrates an example of a method of operating a terminal starting a beam alignment procedure according to an embodiment of the present disclosure. FIG. 12 illustrates a method of operating a terminal (e.g., first terminal 1111) performing beam alignment.

Referring to FIG. 12, in step S1201, the terminal transmits a synchronization signal and first messages. The synchronization signal is used for synchronization with a counterpart terminal (e.g., the second terminal 1112), and the first message is repeatedly transmitted to determine an optimum transmit beam of the terminal or an optimum receive beam of the counterpart terminal. According to an embodiment, after the synchronization signal is first transmit-beam-swept, the first message may be transmit-beam-swept. According to another embodiment, the synchronization signal and the first message may be transmit-beam-swept as a signal group.

In step S1203, the terminal receives an ACK responsive to one of the first messages. A feedback period corresponding to each of the plurality of first messages is configured. By confirming the feedback period in which ACK is received, the terminal may determine which first message the ACK is feedback on among the plurality of first messages. Accordingly, the terminal may confirm that the transmit beam (hereinafter, ‘first transmit beam’) used to transmit the first message corresponding to the feedback period in which the received ACK is transmitted is an optimum transmit beam determined by the counterpart terminal.

In step S1205, the terminal transmits a second message including information related to the received ACK. The information related to the ACK is related to the resource in which the ACK is detected among resources included in the feedback period in which the ACK is received. The counterpart terminal repeatedly transmits the ACK using a plurality of transmit beams through the resources within the feedback period. Accordingly, the resource in which the ACK is detected corresponds to the transmit beam (hereinafter, ‘second transmit beam’) used by the counterpart terminal at the timing when the terminal receives the ACK. Through the second message, the counterpart terminal may confirm that the second transmit beam is an optimum transmit beam. That is, the ACKs transmitted by the counterpart terminal are an indication of the first transmit beam that is the optimum transmit beam of the terminal, and are signals for determining the second transmit beam that is the optimum transmit beam of the counterpart terminal.

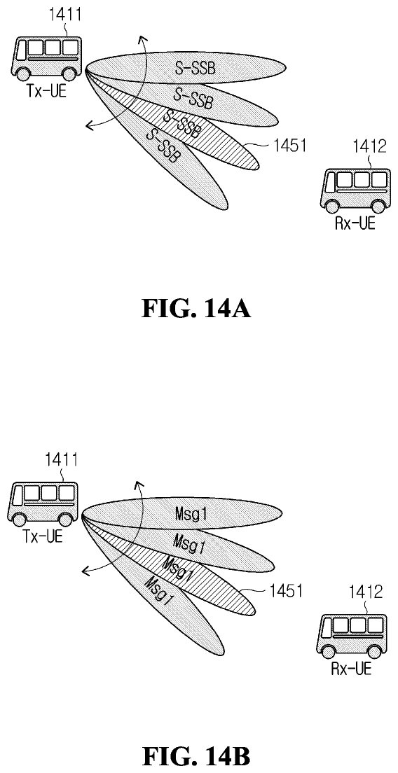

In the embodiments described with reference to FIGS. 12 and 13, after the synchronization signal, the first message is repeatedly transmitted. Here, the first message may include a common reference signal having a sequence different from that of the synchronization signal for synchronization. For example, the common reference signal may have the form of a CSI-RS. According to an embodiment, the sequence of the reference signal included in the first message is different from that of the synchronization signal, but may be generated based on the synchronization signal to express correlation with the synchronization signal. For example, the sequence of the reference signal included in the first message may be generated based on N_{ID}=N^{X}_{ID} mod 2¹⁰. Here, N^{X}_{ID} means a decimal representation of an SLSS ID. In addition, the first message may include short-length padding data of a maximum receivable level even in an incomplete directional communication situation.

In addition, after the transmit beams of two terminals are determined based on the first message and the ACK for the first message, the transmit beam of the terminal that has transmitted the ACK is notified by the second message. Thereafter, the two terminals perform sidelink communication using their respective transmit beams. In this case, according to an embodiment, the second message may function as a message for requesting unicast communication. In other words, the second message may include a direct-link setup request message.

Furthermore, prior to the procedure illustrated in FIGS. 12 and 13, the beam alignment procedure as in the above-described embodiment through a broadcast channel (e.g., sidelink-broadcast channel (SL-BCH)), that is, information indicating presence of the first message following the synchronization signal may be transmitted. For example, the information indicating presence of the first message may be 1-bit Boolean information. Upon receiving the information indicating presence of the first message, the terminal that has detected the synchronization signal may attempt to receive the first message according to the above-described embodiment. In addition, in addition to the information indicating presence of the first message, configuration parameters necessary to operate according to the above-described embodiment, such as information on the number of repetitions of the ACK, information on a time (e.g., number of slots) interval between the first message and the feedback resource, etc. may be transmitted through a broadcast channel.

FIG. 13 illustrates an example of a method of operating a terminal participating in a beam alignment procedure according to an embodiment of the present disclosure. FIG. 13 illustrates a method of operating a terminal (e.g., second terminal 1112) performing beam alignment.

Referring to FIG. 13, in step S1301, a terminal receives a synchronization signal and receives a first message. The synchronization signal is used for synchronization with the counterpart terminal (e.g., the first terminal 1111), and the first message is repeatedly transmitted to determine an optimum receive beam of the terminal or an optimum transmit beam of the counterpart terminal. According to an embodiment, after the synchronization signal is first transmit-beam-swept, the first message may be transmit-beam-swept. According to another embodiment, the synchronization signal and the first message may be transmit-beam-swept as a signal group. In this case, the terminal receives the first message transmitted using the first transmit beam among the plurality of transmit beams with the best reception quality.

In step S1303, the terminal transmits ACKs responsive to the first message using a plurality of transmit beams. A feedback period corresponding to each of the plurality of first messages is configured. Upon receiving the first message, the terminal confirms the feedback period corresponding to the reception timing of the first message, and repeatedly transmits the ACK in the confirmed feedback period. Accordingly, the counterpart terminal may determine which first message the ACK is feedback on among the plurality of first messages. Through this, the counterpart terminal may confirm that the first transmit beam is an optimum transmit beam determined by the terminal.

In step S1305, the terminal receives a second message including information related to one of the ACKs. The information related to the ACK is related to a resource in which the ACK is detected among the resources included in the feedback period in which the ACK is received. The resource in which the ACK is detected corresponds to a transmit beam (hereinafter, ‘second transmit beam’) used by the terminal at the timing when the counterpart terminal receives the ACK. Through the second message, the terminal may confirm that the second transmit beam is an optimum transmit beam. That is, the ACKs transmitted in step S1303 are an indication of a first transmit beam that is an optimum transmit beam of the counterpart terminal, and are signals for determining a second transmit beam that is an optimum transmit beam of the terminal.

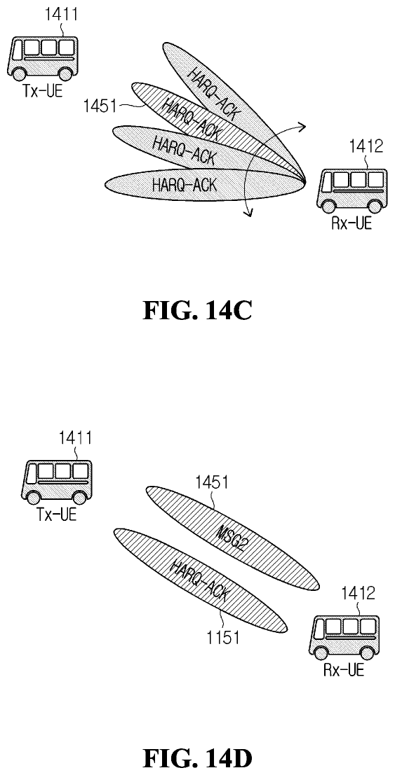

FIGS. 14A to 14D illustrate an example of a procedure for transmit beam alignment between terminals according to an embodiment of the present disclosure. FIGS. 14A to 14D illustrate an example of a beam alignment procedure of a first terminal 1411 which is a transmitting UE (TX-UE) and a second terminal 1412 which is a receiving UE (RX-UE).

The operation of FIG. 14A illustrates a time/frequency synchronization step using sidelink synchronization signals/PSBCH block (S-SSB) defined in 3GPP Release 16. Referring to FIG. 14A, the first terminal 1411 transmits synchronization signals using a plurality of transmit beams. The first terminal 1411 performs transmit beam sweeping for directional communication in a millimeter wave frequency band. The second terminal 1412 acquires synchronization by using the S-SSB transmitted at the timing with the best reception quality (e.g., reference signal received power (RSRP), received signal strength, etc.). In the case of FIG. 14A, the S-SSB transmitted using the transmit beam 1451 provides the best reception quality.

FIG. 14B illustrates a step of determining a transmit beam in a direction from the first terminal 1411 to the second terminal 1412. Referring to FIG. 14B, the first terminal 1411 transmits an initial message MSG1 (message 1). At this time, MSG1 is repeatedly transmitted by transmit beam sweeping, and a plurality of transmit beams spatially divides coverage. The second terminal 1412 may determine, as an optimum transmit beam, a transmit beam used to transmit MSG1 received at the timing with the best reception quality among the repeatedly transmitted MSG1s. In the case of FIG. 14B, a transmit beam 1451 is determined as an optimum transmit beam. According to an embodiment, MSG1 may be repeatedly transmitted according to a start offset in units of slots and a period in units of slots based on subframe number 0 (SFN0). In this case, the second terminal 1412 may perform receive beamforming based on a repetition period.

FIG. 14C illustrates the step of feeding back HARQ-ACK for the MSG1 reception timing selected in the step of FIG. 14B. The HARQ-ACK is repeatedly transmitted as many as the number of transmit beams usable by the second terminal 1412. An optimum transmit beam of the second terminal 1412 may be determined based on the measurement result of the reception quality of the first terminal 1411 for the repeatedly transmitted HARQ-ACKs. That is, the first terminal 1411 confirms the received HARQ-ACK at the timing with the best reception quality among the repeatedly transmitted HARQ-ACKs. In the case of FIG. 14C, a transmit beam 1452 is determined as an optimum transmit beam of the second terminal 1412.

Based on the confirmed resource and timing of the HARQ-ACK, the first terminal 1411 may confirm an optimum transmit beam for a direction from the first terminal 1411 to the second terminal 1412 and an optimum transmit beam for a direction from the second terminal 1412 to the first terminal 1411. In other words, based on the resource in which the received HARQ-ACK is transmitted, the transmit beam 1452, which is the optimum transmit beam for the direction from the second terminal 1412 to the first terminal 1411, is determined, and at the same time, a transmit beam 1451 which is an optimum transmit beam for a direction from 1411 to the second terminal 1412 is confirmed.

For the operation shown in FIG. 14C, the second terminal 1412 repeatedly transmits the HARQ-ACK. The 3GPP Release 16 standard defines sl-PSFCH-Period-r16 as one of the PSFCH configuration parameters, and 0, 1, 2 or 4 slot(s) may be configured as a value of sl-PSFCH-Period-r16. In order to support a larger number of initial transmit beams, 8, 16 slot(s) or more values shall be further defined as configurable values of sl-PSFCH-Period-r16. In addition, the current 3GPP Release 16 standard does not define a sidelink HARQ-ACK repetition. Accordingly, signaling capable of setting a HARQ-ACK repetition factor using a semi-static configuration through RRC shall be defined. In this case, the HARQ-ACK repetition factor may be less than or equal to the value of the aforementioned sl-PSFCH-Period-r16.

FIG. 14D illustrates the step of feeding back the optimum transmit beam for the direction from the second terminal 1412 to the first terminal 1411 determined in the step of FIG. 14C. Referring to FIG. 14D, the first terminal 1411 transmits, to the second terminal 1412, MSG 2 (message 2) including an index of an optimum transmit beam for the direction from the second terminal 1412 to the first terminal 1411. At this time, MSG2 is transmitted using the transmit beam 1451 confirmed in the step of FIG. 14C. The second terminal 1412, which has received MSG2, transmits the HARQ-ACK for MSG2 by using the transmit beam 1452 indicated through MSG2. Through this, the procedure of confirming beam alignment between the first terminal 1411 and the second terminal 1412 is completed.

As with the procedure described with reference to FIGS. 14A to 14D, after synchronization, the respective transmit beams of the two terminals may be aligned using two messages and two HARQ-ACKs. In other words, transmit beam alignment may be achieved by one message beam sweeping, one HARQ-ACK beam sweeping, one message transmission, and one HARQ-ACK transmission. In the above-described embodiment, MSG2 indicates one of the transmit beams of the second terminal 1412. According to an embodiment, information indicating an optimum transmit beam for the direction from the second terminal 1412 to the first terminal 1411 may be included in the form of a MAC CE (control element). For example, the MAC CE may be configured as shown in FIG. 14 below.

FIG. 14 illustrates an example of a MAC CE for delivering beam information according to an embodiment of the present disclosure. FIG. 14 illustrates a structure of a MAC CE used to indicate a selected transmit beam among transmit beams of a counterpart terminal. The MAC CE illustrated in FIG. 14 may be referred to as a ‘beam notification MAC CE’, a ‘sidelink transmit beam candidate notification MAC CE’, or the like. The beam notification MAC CE includes a plurality of reserved bits set to ‘0’ and a beam indication (BI) field 1402. The BI field 1402 indicates a value of a transmit beam candidate and may have a 4-bit size. The beam notification MAC CE may be identified by a MAC subheader having an LCID value defined as shown in Table 9 below. Table 9 illustrates mapping of indices and LCID values for a sidelink-shared channel (SL-SCH) according to an embodiment.

TABLE 9

| Index | LCID values |
|---|---|
| 0 | SCCH carrying PC5-S messages that are not protected |
| 1 | SCCH carrying PC5-S messages “Direct Security Mode |
| | Command” and “Direct Security Mode Complete” |
| 2 | SCCH carrying other PC5-S messages that are protected |
| 3 | SCCH carrying PC5-RRC messages |
| 4-19 | Identity of the logical channel |
| 20-60 | Reserved |
| 61 | Sidelink Tx Beam Candidate Notification |
| 62 | Sidelink CSI Reporting |
| 63 | Padding |

The priority of the beam notification MAC CE may be fixed to ‘1’.

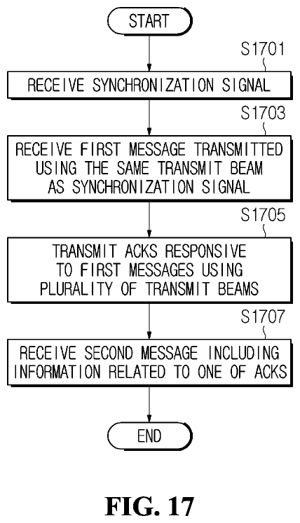

FIG. 16 illustrates an example of a method of operating a terminal starting a transmit beam alignment procedure according to an embodiment of the present disclosure. FIG. 16 illustrates a method of operating a terminal (e.g., the first terminal 1411) performing transmit beam alignment.

Referring to FIG. 16, in step S1601, the terminal transmits synchronization signals using a plurality of transmit beams. The terminal repeatedly transmits the synchronization signal using a plurality of transmit beams so that the counterpart terminal (e.g., the second terminal 1422) may receive at least one of the synchronization signals.

In step S1603, the terminal transmits first messages using a plurality of transmit beams. In order for the counterpart terminal to receive at least one of the first messages, the terminal repeatedly transmits the synchronization signal using the plurality of transmit beams. In this case, the counterpart terminal receives the first message transmitted using the first transmit beam among the plurality of transmit beams.

In step S1605, the terminal receives ACK responsive to one of the first messages. A feedback period corresponding to each of the plurality of first messages is configured, and the terminal monitors the feedback period corresponding to each of the transmission timings of the first message, so that the terminal may receive ACK for the first message transmitted at one of the timings when the first messages are transmitted. Since the counterpart terminal transmits ACK in response to the first message received with the best reception quality, the ACK functions as information indicating that the first transmit beam is an optimum transmit beam.

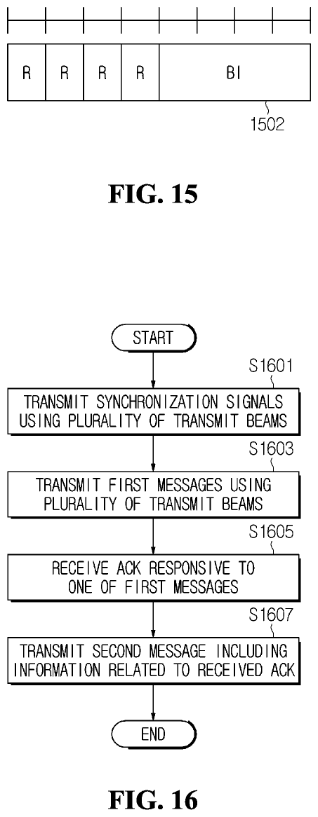

In step S1607, the terminal transmits a second message including information related to the received ACK. The information related to the ACK indicates a resource in which the ACK is detected among resources included in the feedback period in which the ACK is received. The counterpart terminal repeatedly transmits the ACK using a plurality of transmit beams by performing transmit beam sweeping through resources within the feedback period. Accordingly, the resource in which the ACK is detected corresponds to the transmit beam (hereinafter, ‘second transmit beam’) used by the counterpart terminal at the timing when the terminal receives the ACK. Accordingly, the information related to the ACK may include an indication of the resource in which the ACK is received, a timing when the ACK is received, or a second transmit beam. For example, the second message may include the MAC CE illustrated in FIG. 15. Through the second message, the counterpart terminal may determine that the second transmit beam is the optimum transmit beam.

Thereafter, although not shown in FIG. 16, the terminal may receive ACK responsive to the second message. The ACK is transmitted using the second transmit beam of the counterpart terminal indicated by the second message.

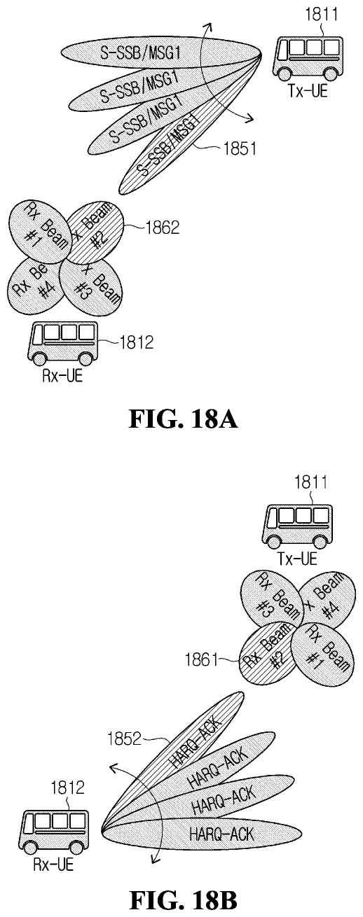

FIG. 17 illustrates an example of a method of operating a terminal participating in a transmit beam alignment procedure according to an embodiment of the present disclosure. FIG. 17 illustrates a method of operating a terminal (e.g., the second terminal 1412) performing transmit beam alignment.

Referring to FIG. 17, in step S1701, the terminal receives a synchronization signal. The synchronization signal is repeatedly transmitted from the counterpart terminal (e.g., the first terminal 1411) using a plurality of transmit beams. Among the synchronization signals transmitted using the plurality of transmit beams, the terminal detects the synchronization signal transmitted using the first transmit beam.

In step S1703, the terminal receives the first message transmitted using the same transmit beam as the synchronization signal. The first message is repeatedly transmitted from the counterpart terminal using a plurality of transmit beams. Among the first messages transmitted using the plurality of transmit beams, the terminal receives the first message transmitted using the first transmit beam with the best reception quality. Through this, an optimum first transmit beam for a direction from the counterpart terminal to the terminal is determined.

In step S1705, the terminal transmits ACKs responsive to the first messages using a plurality of transmit beams. That is, the terminal performs transmit beam sweeping. ACKs are transmitted in the feedback period corresponding to the first message received in step S1703. Since the ACK is feedback on the first message transmitted using the first transmit beam from the counterpart terminal, the ACK functions as information indicating that the first transmit beam is an optimum transmit beam.

In step S1707, the terminal receives a second message including information related to one of the ACKs. The information related to the ACK indicates a resource in which the counterpart terminal detects the ACK among resources included in the feedback period in which the ACK is received. The resource in which the ACK is detected corresponds to a transmit beam (hereinafter, ‘second transmit beam’) used by the terminal at the timing when the counterpart terminal receives the ACK. Accordingly, the information related to the ACK may include an indication of a resource in which the ACK is received, a timing when the ACK is received, or a second transmit beam. For example, the second message may include the MAC CE illustrated in FIG. 15. Through this, an optimum second transmit beam for a direction from the terminal to the counterpart terminal is confirmed.

Thereafter, although not shown in FIG. 17, the terminal may transmit ACK responsive to the second message. The ACK is transmitted using the second transmit beam of the terminal indicated by the second message.

According to the embodiments described with reference to FIGS. 14A to 17, beam alignment between terminals may be performed. In the above-described embodiments, the transmit beams of the two terminals are aligned. Based on the repeated transmission of the sidelink initial message (e.g., MSG1) through transmit beam sweeping over all coverage of a spatial area and the reception timing of the HARQ-ACK feedback for this, the transmit beam of the terminal that started the procedure (e.g., the first terminal) may be determined. In addition, instead of the RACH, by combining the HARQ-ACK repetition technique of repeatedly transmitting HARQ-ACK through the PSFCH configured for each UE with transmit beamforming, that is, by transmitting HARQ-ACKs through transmit beam sweeping, the transmit beam of the terminal (e.g., the second terminal) participating in the procedure may be determined. The determined transmit beam may be notified by a sidelink message (e.g., MSG2) following the sidelink initial message. Accordingly, optimum transmit beams that enable directional communication may be determined even without the RACH.

However, the above-described embodiments do not include receive beam matching. When an omni-directional beam is used as a receive beam or channel reciprocity is secured, additional receive beam matching may not be required. However, when channel reciprocity is not guaranteed or when the characteristics of the transmit beam and the receive beam are different, for example, when the beam width of the receive beam is wider than that of the transmit beam, beam alignment for the receive beam may be required. Accordingly, the present disclosure describes embodiments of beam alignment including not only transmit beam alignment but also receive beam alignment.

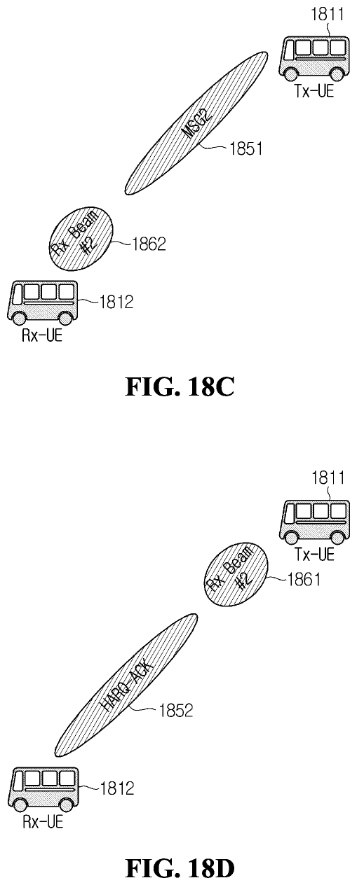

FIGS. 18A to 18D illustrate an example of a procedure for transmit/receive beam alignment between terminals according to an embodiment of the present disclosure. FIG. 18A to 18D illustrate another example of a beam alignment procedure of a first terminal 1811 which is a transmitting UE (TX-UE) and a second terminal which is a receiving UE (RX-UE).

FIG. 18A illustrates synchronization and initial Beam Discovery steps. Referring to FIG. 18A, a synchronization step using an S-SSB is performed according to the 3GPP NR sidelink standard. In the case of using a millimeter wave, up to 64 S-SSBs may be transmitted during an S-SSB period having a length of 160 ms. According to an embodiment, the first terminal 1811 transmits each S-SSB in 360-degree omnidirectional or partial directions using a plurality of different transmit beams, and the second terminal 1812 may perform synchronization using the receive beams for a period of up to [160 ms x the number of receive beams]. As a result, the second terminal 1812 may acquire synchronization by using the receive beam aligned with the transmit beam used to transmit the S-SSB.

Subsequently to the S-SSB, MSG1s are transmitted in a direction from the first terminal 1811 to the second terminal 1812. The first terminal 1811 repeatedly transmits MSG1 in all or some directions within coverage through a transmit beam sweeping operation. MSG1 may be referred to as a ‘beam discovery request message’. MSG1 may be transmitted between two consecutive S-SSBs during the S-SSB period, has an offset (e.g., BeamDisc_Offset offset) in units of slots compared to the S-SSB slot, and may be repeatedly transmitted using the same transmit beam a predetermined number of times (e.g., NumBeamDisc) every predetermined interval (e.g., BeamDisc_Interval). In this case, the second terminal 1812 may receive MSG1s repeatedly transmitted from the first terminal 1811 using different receive beams. In the case of FIG. 18A, the S-SSB and MSG1 transmitted using the transmit beam 1851 are received using the receive beam 1862.

FIG. 18B illustrates a Beam Discovery Response step. Referring to FIG. 18B, HARQ-ACK is transmitted as a response to MSG1 in a direction from the second UE 1812 toward the first UE 1811. The second UE 1812 transmits HARQ-ACK through a PSFCH in response to the received MSG1. Here, the HARQ-ACK may be referred to as a ‘beam discovery response message’. That is, the response to MSG1 is ACK-only feedback and has a HARQ-ACK feedback structure.

Among the repeatedly transmitted MSG1s, consecutive MSG1s may be received by the second terminal 1812. At this time, when feedback on consecutive MSG1s is configured to be transmitted in the same slot through the same PSFCH, the second terminal 1812 transmits HARQ-ACK in response to MSG1 with the best reception quality through a PSFCH corresponding to the received MSG1s. On the other hand, when feedback on consecutive MSG1s is configured to be transmitted through different PSFCHs, the second terminal 1812 transmits HARQ-ACK through the PSFCH corresponding to MSG1 with the best reception quality in response to MSG1 with the best reception quality. In addition, the HARQ-ACK for MSG1 corresponding to another PSFCH is not transmitted even though MSG1 is received.

When transmitting the HARQ-ACK, the second terminal 1812 repeatedly transmits the same HARQ-ACK through the PSFCH a predetermined number of times (e.g., NumBeamDiscResp) by performing transmit beam sweeping in consecutive slots. The first terminal 1811 may confirm the optimum transmit beam of the second terminal 1812 through the HARQ-ACK. In the case of FIG. 18B, the HARQ-ACK transmitted using the transmit beam 1852 is received. Accordingly, the transmit beam 1852 is determined as an optimum transmit beam of the second terminal 1812.

Also, the first terminal 1811 may confirm the optimum transmit beam of the first terminal 1811 based on a time difference between MSG1 and HARQ-ACK. The first terminal 1811 uses the receive beam 1861 corresponding to the transmit beam 1851 used to transmit the most recent MSG1 to receive the HARQ-ACKs repeatedly transmitted from the second terminal 1812. In general, since a receive beam has a wider beam width than a transmit beam, a plurality of transmit beams may correspond to one receive beam.

FIGS. 18C and 18D illustrate a beam discovery confirm step. Referring to FIG. 18C, MSG2 is transmitted in the direction from the second terminal 1812 to the first terminal 1811, using the transmit beam 1851 determined through the beam discovery step, and is received using the receive beam 1862. MSG2 may be referred to as a ‘Beam Discovery Confirm Request message’. MSG2 may include information on the transmit beam 1852 of the second terminal 1812 determined in the direct-link setup request and beam discovery step for unicast mode V2X communication. For example, information on the transmit beam 1852 of the second terminal 1812 may be included in the form of the MAC CE illustrated in FIG. 15. In this case, in order to quickly complete the initial beam alignment, a beam discovery confirm message after the beam discovery process, that is, a slot offset in which MSG2 may be transmitted and a period length may be configured or pre-configured.

Thereafter, as shown in FIG. 18D, the HARQ-ACK is transmitted through the PSFCH. In this case, the HARQ-ACK is transmitted using the transmit beam 1852 determined through the beam discovery step and the beam discovery response step in the direction from the second terminal 1812 to the first terminal 1811, and is received using the receive beam 1861. Here, the HARQ-ACK may be referred to as a ‘beam discovery confirm message’. That is, the response to MSG2 is ACK-only feedback and has a HARQ-ACK feedback structure.

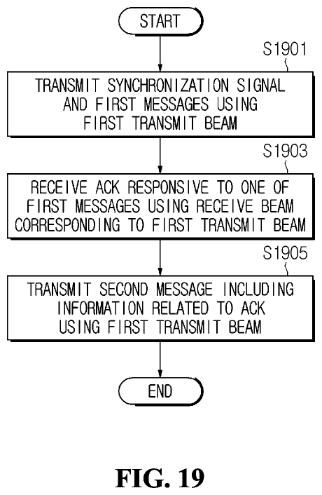

FIG. 19 illustrates an example of a method of operating a terminal starting a transmit/receive beam alignment procedure according to an embodiment of the present disclosure. FIG. 19 illustrates a method of operating a terminal (e.g., the first terminal 1811) performing alignment of a transmit beam and a receive beam.

Referring to FIG. 19, in step S1901, the terminal transmits a synchronization signal and first messages using a first transmit beam. One synchronization signal and a plurality of first messages are continuously transmitted using one beam. Here, the first messages are repetitions of the same message, and are transmitted with the same transmit beam for receive beam sweeping of the counterpart terminal (e.g., the second terminal 1812). Although not shown in FIG. 19, prior to step S1901, the synchronization signal and the first messages may have been transmitted using at least one other beam. That is, the terminal transmits the synchronization signal and the first messages as one signal group, and repeatedly transmits the signal group using a plurality of transmit beams.

In step S1903, the terminal receives ACK responsive to one of the first messages by using a receive beam corresponding to the first transmit beam. A feedback period corresponding to each of the plurality of first messages is configured, and the terminal monitors the feedback period corresponding to each of the transmission timings of the first messages, so that the terminal may receive ACK in response to the first message transmitted at one of the timings when the first messages are transmitted. Since the counterpart terminal transmits ACK in response to the first message received with the best reception quality during receive beam sweeping, it may be determined that the receive beam (hereinafter, ‘first receive beam’) used at the transmission timing of the first message corresponding to the ACK is an optimum receive beam. In addition, since the ACK is feedback on the first message transmitted using the first transmit beam, the ACK also functions as information indicating that the first transmit beam is an optimum transmit beam. In this case, the terminal monitors the feedback period using a receive beam (hereinafter, ‘second receive beam’) corresponding to the first transmit beam, that is, a second receive beam having a coverage including the coverage of the first transmit beam.

In step S1905, the terminal transmits a second message including information related to the ACK using the first transmit beam. The information related to the ACK indicates a resource in which the ACK is detected among resources included in the feedback period in which the ACK is received. The counterpart terminal repeatedly transmits the ACK using a plurality of transmit beams by performing transmit beam sweeping through resources within the feedback period. Accordingly, the resource in which the ACK is detected corresponds to the transmit beam (hereinafter, ‘second transmit beam’) used by the counterpart terminal at the timing when the terminal receives the ACK. Accordingly, the information related to the ACK may include an indication of a resource in which the ACK is received, a timing when the ACK is received, or a second transmit beam. For example, the second message may include the MAC CE illustrated in FIG. 15. Through the second message, the counterpart terminal may confirm the optimum transmit beam for the second transmit beam.

Thereafter, although not shown in FIG. 19, the terminal may receive ACK in response to the second message. The ACK may be transmitted using the second transmit beam of the counterpart terminal indicated by the second message, and may be received using the second receive beam corresponding to the first transmit beam of the terminal.

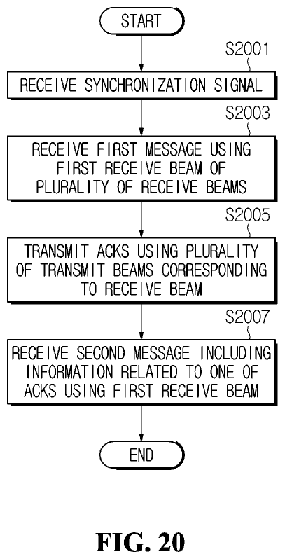

FIG. 20 illustrates an example of a method of operating a terminal participating in a transmit/receive beam alignment procedure according to an embodiment of the present disclosure. FIG. 20 illustrates a method of operating a terminal (e.g., the second terminal 1812) performing alignment of a transmit beam and a receive beam.

Referring to FIG. 20, in step S2001, the terminal receives a synchronization signal. The synchronization signal is transmitted from the counterpart terminal (e.g., the first terminal 1811) using one transmit beam (hereinafter, ‘first transmit beam’) among a plurality of transmit beams. Accordingly, the terminal attempts to receive at least one of the first messages transmitted subsequently to the synchronization signal.

In step S2003, the terminal receives the first message using the first receive beam among the plurality of receive beams. In order to receive the first message repeatedly transmitted from the counterpart terminal, the terminal performs receive beam sweeping using a plurality of receive beams. That is, a plurality of receive beams is used at different timings. In this case, the first message is received with the best reception quality at the timing when the first receive beam is used. Accordingly, the terminal may determine that the first receive beam is an optimum receive beam. Through this, an optimum first beam pair including the first transmit beam and the first receive beam for the direction from the counterpart terminal to the terminal is determined.

In step S2005, the terminal transmits ACKs using a plurality of transmit beams corresponding to the first receive beam. That is, the terminal performs transmit beam sweeping. In this case, the used transmit beams are transmit beams having coverage included in the coverage of the first receive beam among all the transmit beams. In addition, ACKs are transmitted in the feedback period corresponding to the first message received in step S2003. Since the ACK is feedback on the first message transmitted using the first transmit beam from the counterpart terminal, the ACK functions as information indicating that the first transmit beam is an optimum transmit beam. In this case, the counterpart terminal receives at least one of the ACKs using a receive beam (hereinafter, ‘second reception beam’) corresponding to the first transmit beam.

In step S2007, the terminal receives a second message including information related to one of the ACKs using the first receive beam. The information related to the ACK indicates a resource in which the counterpart terminal detects the ACK among resources included in the feedback period in which the ACK is received. The resource in which the ACK is detected corresponds to a transmit beam (hereinafter, ‘second transmit beam’) used by the terminal at the timing when the counterpart terminal receives the ACK. Accordingly, the information related to the ACK may include an indication of a resource in which the ACK is received, a timing when the ACK is received, or a second transmit beam. For example, the second message may include the MAC CE illustrated in FIG. 15. Through the second message, the terminal may confirm an optimum transmit beam. Through this, an optimum second beam pair including the second transmit beam and the second receive beam for a direction from the counterpart terminal to the terminal is confirmed.

Thereafter, although not shown in FIG. 20, the terminal may transmit ACK on the second message. The ACK may be transmitted using the second transmit beam of the terminal indicated by the second message, and may be received by the other terminal using the second receive beam.

According to the embodiments described with reference to FIGS. 18A to 20, transmit/receive beam alignment between terminals may be performed. According to the above-described embodiments, all of the peer terminals performing sidelink communication may perform bidirectional transmit beamforming. Also, all of the peer terminals may perform receive beamforming. By performing transmit/receive beamforming, V2X communication coverage may be extended.

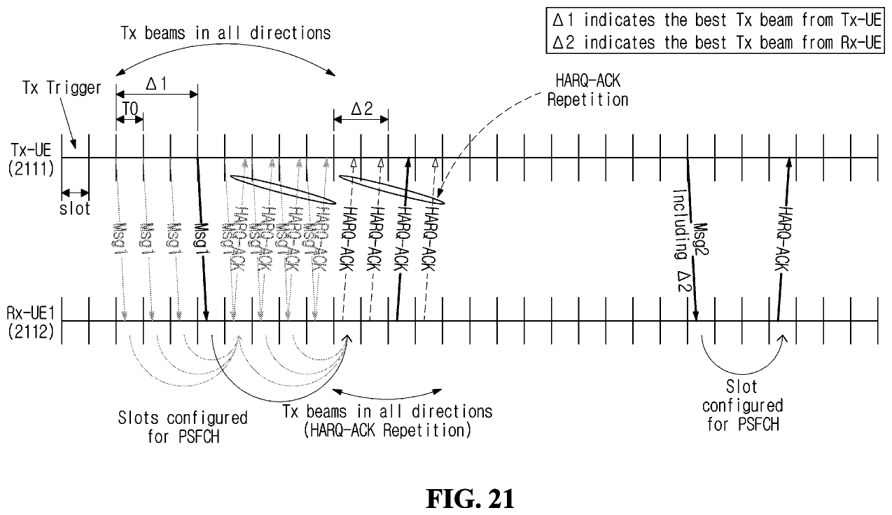

FIG. 21 illustrates a first example of signal exchange for transmit beam alignment between terminals according to an embodiment of the present disclosure. FIG. 21 illustrates signal exchange for beam alignment in a situation where sl-PSFCH-Period-r16 is set to s14, sl-MinTimeGapPSFCH-16 is set to s12, a HARQ-ACK repetition factor is set to 4, the transmitting UE 2111 supports 8 transmit beams, the receiving UE 2112 supports 4 transmit beams, and a repeated transmission interval T0 is set to one-slot, as a case of performing transmit beam alignment.

Referring to FIG. 21, a transmitting UE 2111 repeatedly transmits Msg1 8 times at an interval of T0 using transmit beams in all 8 directions. T0 means a transmission time interval between consecutive transmit beams of the transmitting UE 2111. A PSFCH is configured for 8 transmission timings. In the example of FIG. 21, HARQ-ACKs are bundled or multiplexed. Accordingly, a first PSFCH corresponding to the first three Msg1s out of eight and a second PSFCH corresponding to the next four Msg1s are configured.

In the example of FIG. 21, the fourth Msg1 transmitted after Δ1 from the first Msg1 transmission is received by the receiving terminal 2112 with the best reception quality. Δ1 indicates the optimum transmit beam of the transmitting UE 2111, and is 3-slot in the case of FIG. 21. Accordingly, since the fourth Msg1 corresponds to the second PSFCH, the receiving UE 2112 transmits HARQ-ACK through a second PSFCH. At this time, according to the value of the HARQ-ACK repetition factor of 4, the receiving UE 2112 repeatedly transmits HARQ-ACK 4 times at 1-slot intervals using transmit beams in all 4 directions. The third HARQ-ACK transmitted after Δ2 from the first HARQ-ACK transmission is received by the transmitting terminal 2111 with the best reception quality. Δ2 indicates an optimum transmit beam of the receiving UE 2112, and is 2-slot in the case of FIG. 21. Thereafter, the transmitting UE 2111 transmits Msg2 including Δ2, and the receiving UE 2112 transmits the HARQ-ACK in response to Msg2 using the transmit beam indicated by Δ2 through the PSFCH corresponding to Msg2.

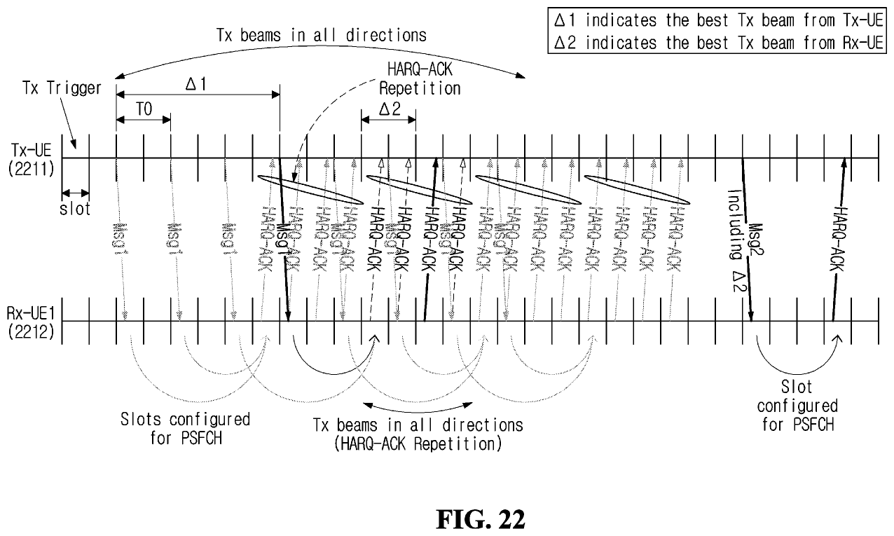

FIG. 22 illustrates a second example of signal exchange for transmit beam alignment between terminals according to an embodiment of the present disclosure. FIG. 22 illustrates signal exchange for beam alignment in a situation where sl-PSFCH-Period-r16 is set to s14, sl-MinTimeGapPSFCH-16 is set to s12, a HARQ-ACK repetition factor is set to 4, the transmitting UE 2211 supports 8 transmit beams, the receiving UE 2212 supports 4 transmit beams, and a repeated transmission interval T0 is set to 2-slot, as a case of performing transmit beam alignment.

Referring to FIG. 22, a transmitting UE 2211 repeatedly transmits Msg1 8 times at an interval of T0 using transmit beams in all 8 directions. T0 means a transmission time interval between consecutive transmit beams of the transmitting UE 2211. The PSFCH is configured for 8 transmission timings. In the example of FIG. 22, HARQ-ACKs are bundled or multiplexed by two. Accordingly, for 8 Msg1 transmission timings, 4 PSFCHs are configured.

In the example of FIG. 22, the fourth Msg1 transmitted after Δ1 from the first Msg1 transmission is received by the receiving terminal 2212 with the best reception quality. Δ1 indicates an optimum transmit beam of the transmitting UE 2211, and is 6-slot in the case of FIG. 22. Accordingly, the receiving UE 2212 transmits HARQ-ACK through the PSFCH corresponding to the fourth Msg1. At this time, according to the value of the HARQ-ACK repetition factor of 4, the receiving UE 2212 repeatedly transmits HARQ-ACK 4 times at 1-slot intervals using transmit beams in all 4 directions. The third HARQ-ACK transmitted after Δ2 from the first HARQ-ACK transmission is received by the transmitting terminal 2211 with the best reception quality. Δ2 indicates an optimum transmit beam of the receiving UE 2212, and is 2-slot in the case of FIG. 22. Thereafter, the transmitting UE 2211 transmits Msg2 including Δ2, and the receiving UE 2212 transmits the HARQ-ACK to Msg2 using the transmit beam indicated by Δ2 through the PSFCH corresponding to Msg2.

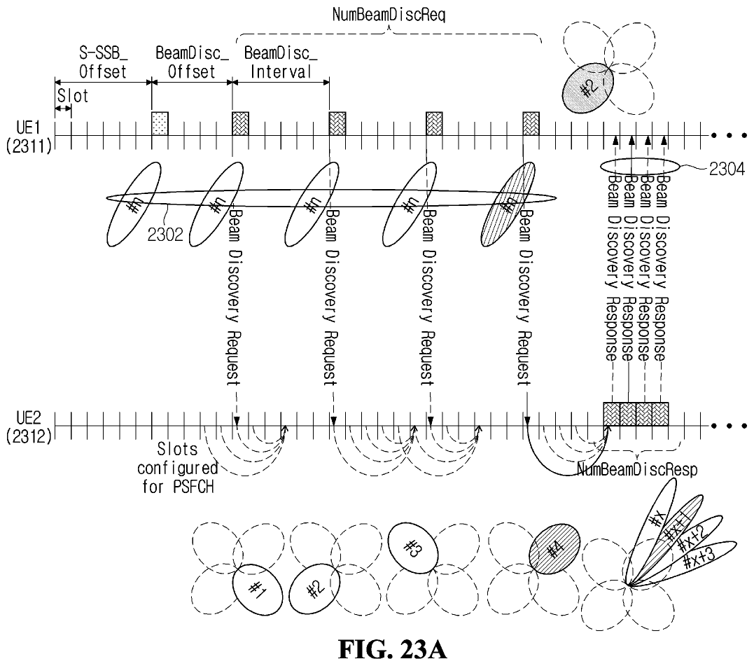

FIGS. 23A and 23B illustrate an example of signal exchange for transmit/receive beam alignment between terminals according to an embodiment of the present disclosure. FIGS. 23A and 23B illustrates signal exchange for beam alignment in a situation where sl-PSFCH-Period-r16 is set to s14, sl-MinTimeGapPSFCH-16 is set to s12, a HARQ-ACK repetition factor is set to 4, UE1 2311 and UE2 2312 support four receive beams, and one receive beam corresponds to four transmit beams, as a case of performing transmit/receive beam alignment.

Referring to FIGS. 23A and 23B, the UE1 2311 transmits an S-SSB using transmit beam #n in the slots after the S-SSB_Offset slots from a reference slot. After the BeamDisc_Offset slots from the slot in which the S-SSB is transmitted, the UE1 2311 repeatedly transmits a beam discovery request message NumBeamDiscReq times using transmit beam #n at intervals of DbeamDisc_Interval slots. The S-SBB transmission using transmit beam #n and the beam discovery request message transmission of NumBeamDiscReq times constitute a TX beam cluster 2302 of the UE1 2311. During the transmit beam cluster 2302, the UE2 2312 attempts to receive a beam discovery request message using receive beams #1 to #4. In the example of FIGS. 23A and 23B, the beam discovery request message is received with the best reception quality at the timing using receive beam #4.

Accordingly, the UE2 2312 repeatedly transmits a beam discovery response message (e.g., HARQ-ACK for a beam discovery request message) through the PSFCH corresponding to the timing using receive beam #4 using transmit beam #x to transmit beam X+3. The beam discovery response message transmission of NumBeamDiscResp times constitutes the transmit beam cluster 2304 of the UE2 2312. During the transmit beam cluster 2304, the UE1 2311 attempts to receive a beam discovery response message using receive beam #2 in the PSFCH corresponding to the fourth beam discovery request message. Although not shown in FIG. 21, the UE1 2311 may attempt to receive the beam discovery response message even in PSFCHs corresponding to the first to third beam discovery request messages. In the example of FIGS. 23A and 23B, the beam discovery response message is received with the best reception quality at the timing using transmit beam #x+1. Accordingly, the UE1 2311 may determine that transmit beam #n of the UE1 2311 and transmit beam #x+1 of the UE2 2312 are optimum transmit beams.

Thereafter, during a beam discovery confirm window or a direct-link setup message reception window, the direct-link setup request and confirm signaling are performed. Specifically, the UE1 2311 transmits a beam discovery confirm request message using transmit beam #n. The beam discovery confirm request message includes a direct-link setup request message, and may include an index of transmit beam #x+1, which is an optimum transmit beam of the UE2 2312. The UE2 2312 receives the beam discovery confirm request message using receive beam #4, and the beam discovery confirm message (e.g., HARQ-ACK for the beam discovery confirm request) is transmitted using transmit beam #x+1 indicated by the beam discovery confirm request message. Thereafter, a direct link procedure is performed, and the UE2 2312 transmits a direct-link setup completion message using transmit beam #x+1. In this case, UE1 2311 may receive a beam discovery confirm message and a direct-link setup completion message using receive beam #2.

System and Various Devices to which Embodiments of the Present Disclosure are Applicable

Various embodiments of the present disclosure may be combined with each other.

Hereinafter, a device to which various embodiments of the present disclosure may be applied will be described. Although not limited thereto, various descriptions, functions, procedures, proposals, methods, and/or operation flowcharts disclosed in this document may be applied to various fields requiring wireless communication/connection (e.g., 5G) between devices.

Hereinafter, it will be described in more detail with reference to the drawings. In the following drawings/description, the same reference numerals may represent the same or corresponding hardware blocks, software blocks, or functional blocks, unless otherwise indicated.

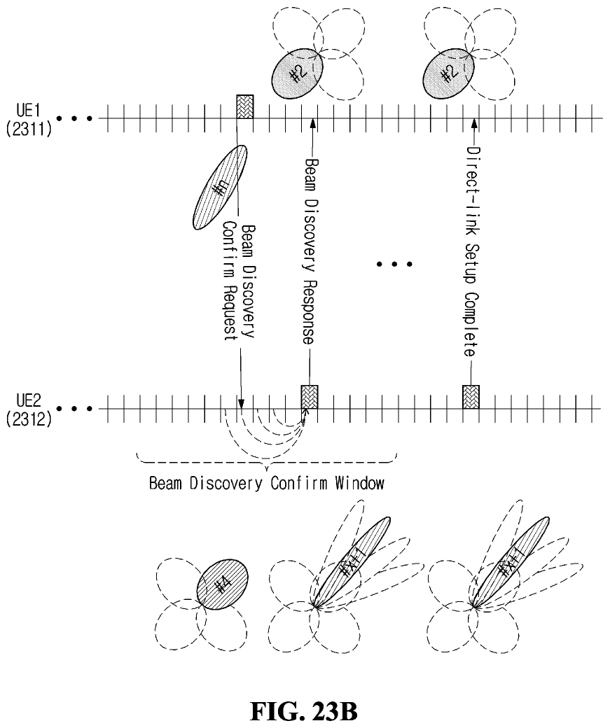

FIG. 24 illustrates a communication system, in accordance with an embodiment of the present disclosure. The embodiment of FIG. 24 may be combined with various embodiments of the present disclosure.

Referring to FIG. 24, the communication system applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include at least one of a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120a to 120e network may be implemented by a wireless device, and a specific wireless device 120a may operate as a base station/network node for another wireless device.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network through the base station 120. AI technology is applicable to the wireless devices 100a to 100f, and the wireless devices 100a to 100f may be connected to the AI server 100g through the network. The network may be configured using a 3G network, a 4G (e.g., LTE) network or a 5G (e.g., NR) network, etc. The wireless devices 100a to 100f may communicate with each other through the base stations 120a to 120e or perform direct communication (e.g., sidelink communication) without through the base stations 120a to 120e. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base stations 120a to 120e and the base stations 120a to 120e/the base stations 120a to 120e. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (JAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

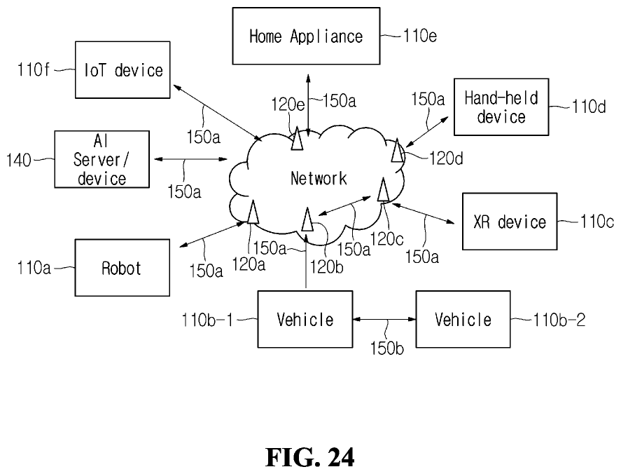

FIG. 25 illustrates wireless devices, in accordance with an embodiment of the present disclosure. The embodiment of FIG. 25 may be combined with various embodiments of the present disclosure.

Referring to FIG. 25, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 24.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may perform wireless communications with the first wireless device 200a and may include one or more processors 202b and one or more memories 204b and may further include one or more transceivers 206b and/or one or more antennas 208b. The functions of the one or more processors 202b, one or more memories 204b, one or more transceivers 206b, and/or one or more antennas 208b are similar to those of one or more processors 202a, one or more memories 204a, one or more transceivers 206a and/or one or more antennas 208a of the first wireless device 200a.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs), one or more service data unit (SDU), messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. In addition, one or more transceivers 206a and 206b may be coupled with one or more antennas 208a and 208b, and may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

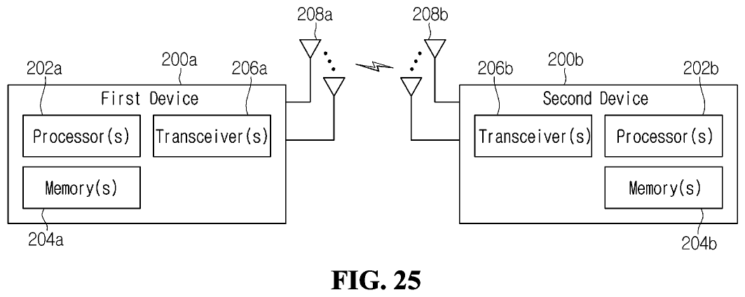

FIG. 26 illustrates a signal process circuit for a transmission signal, in accordance with an embodiment of the present disclosure. The embodiment of FIG. 26 may be combined with various embodiments of the present disclosure.

Referring to FIG. 26, a signal processing circuit 300 may include scramblers 310, modulators 320, a layer mapper 330, a precoder 340, resource mappers 350, and signal generators 360. For example, an operation/function of FIG. 26 may be performed by the processors 202a and 202b and/or the transceivers 36 and 206 of FIG. 25. Hardware elements of FIG. 26 may be implemented by the processors 202a and 202b and/or the transceivers 36 and 206 of FIG. 25. For example, blocks 310 to 360 may be implemented by the processors 202a and 202b of FIG. 25. Alternatively, the blocks 310 to 350 may be implemented by the processors 202a and 202b of FIG. 25 and the block 360 may be implemented by the transceivers 36 and 206 of FIG. 25, and it is not limited to the above-described embodiment.

Codewords may be converted into radio signals via the signal processing circuit 300 of FIG. 26. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 310. Scramble sequences used for scrambling may be generated based on an initialization value, and the initialization value may include ID information of a wireless device. The scrambled bit sequences may be modulated to modulation symbol sequences by the modulators 320. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 330. Modulation symbols of each transport layer may be mapped (precoded) to corresponding antenna port(s) by the precoder 340. Outputs z of the precoder 340 may be obtained by multiplying outputs y of the layer mapper 330 by an N*M precoding matrix W. Herein, N is the number of antenna ports and M is the number of transport layers. The precoder 340 may perform precoding after performing transform precoding (e.g., DFT) for complex modulation symbols. Alternatively, the precoder 340 may perform precoding without performing transform precoding.

The resource mappers 350 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 360 may generate radio signals from the mapped modulation symbols and the generated radio signals may be transmitted to other devices through each antenna. For this purpose, the signal generators 360 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures of FIG. 26. For example, the wireless devices (e.g., 200a and 200b of FIG. 25) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

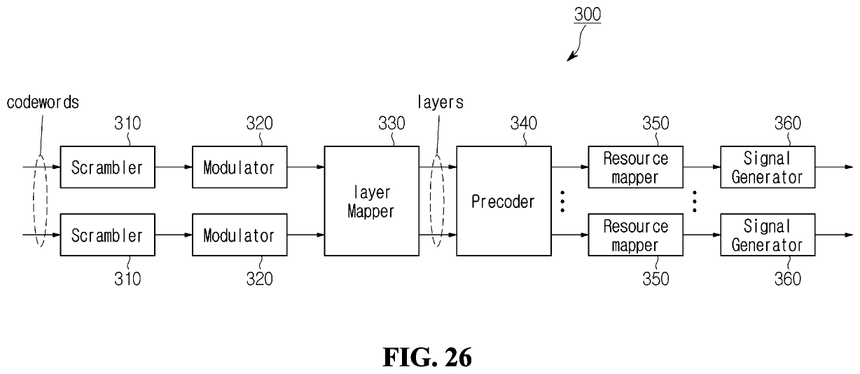

FIG. 27 illustrates a wireless device, in accordance with an embodiment of the present disclosure. The embodiment of FIG. 27 may be combined with various embodiments of the present disclosure.

Referring to FIG. 27, a wireless device 300 may correspond to the wireless devices 200a and 200b of FIG. 25 and include various elements, components, units/portions and/or modules. For example, the wireless device 300 may include a communication unit 310, a control unit (controller) 320, a memory unit (memory) 330 and additional components 340.

The communication unit 410 may include a communication circuit 412 and a transceiver(s) 414. The communication unit 410 may transmit and receive signals (e.g., data, control signals, etc.) to and from other wireless devices or base stations. For example, the communication circuit 412 may include one or more processors 202a and 202b and/or one or more memories 204a and 204b of FIG. 25. For example, the transceiver(s) 414 may include one or more transceivers 206a and 206b and/or one or more antennas 208a and 208b of FIG. 42.

The control unit 420 may be composed of at least one processor set. For example, the control unit 420 may be composed of a set of a communication control processor, an application processor, an electronic control unit (ECU), a graphic processing processor, a memory control processor, etc. The control unit 420 may be electrically coupled with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The memory unit 430 may be composed of a random access memory (RAM), a dynamic RAM (DRAM), a read only memory (ROM), a flash memory, a volatile memory, a non-volatile memory and/or a combination thereof. The memory unit 430 may store data/parameters/programs/codes/commands necessary to derive the wireless device 400. In addition, the memory unit 430 may store input/output data/information, etc.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 41, 100a), the vehicles (FIG. 41, 100b-1 and 100b-2), the XR device (FIG. 41, 100c), the hand-held device (FIG. 41, 100d), the home appliance (FIG. 41, 100e), the IoT device (FIG. 41, 100f), a digital broadcast terminal, a hologram apparatus, a public safety apparatus, an MTC apparatus, a medical apparatus, a Fintech device (financial device), a security device, a climate/environment device, an AI server/device (FIG. 41, 140), the base station (FIG. 41, 120), a network node, etc. The wireless device may be movable or may be used at a fixed place according to use example/service.

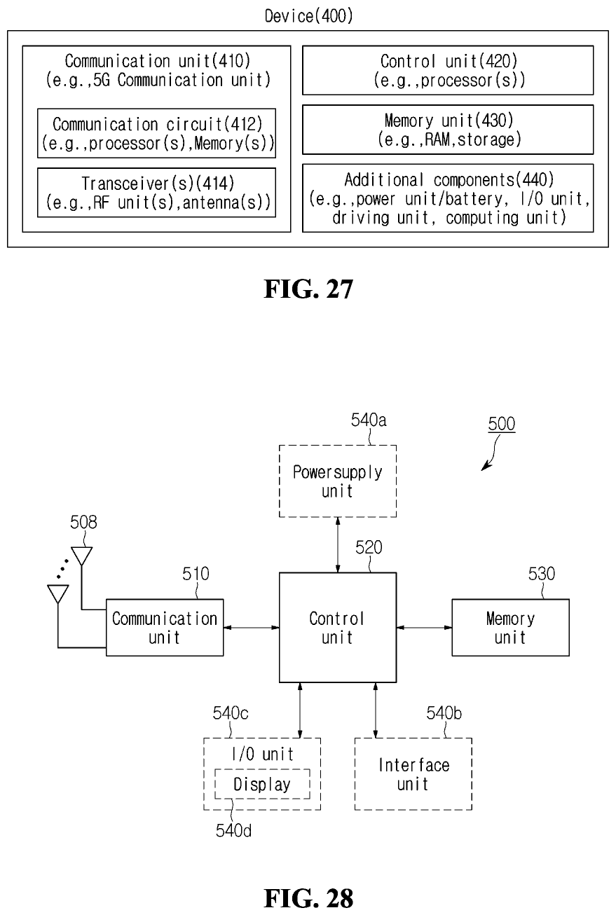

FIG. 28 illustrates a hand-held device, in accordance with an embodiment of the present disclosure. FIG. 28 exemplifies a hand-held device applicable to the present disclosure. The hand-held device may include a smartphone, a smart pad, a wearable device (e.g., a smart watch or smart glasses), and a hand-held computer (e.g., a laptop, etc.). The embodiment of FIG. 28 may be combined with various embodiments of the present disclosure.

Referring to FIG. 28, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/440a to 540c may correspond to the blocks 310 to 330/340 of FIG. 27, respectively, and duplicate descriptions are omitted.

The communication unit 510 may transmit and receive signals and the control unit 520 may control the hand-held device 500, and the memory unit 530 may store data and so on. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

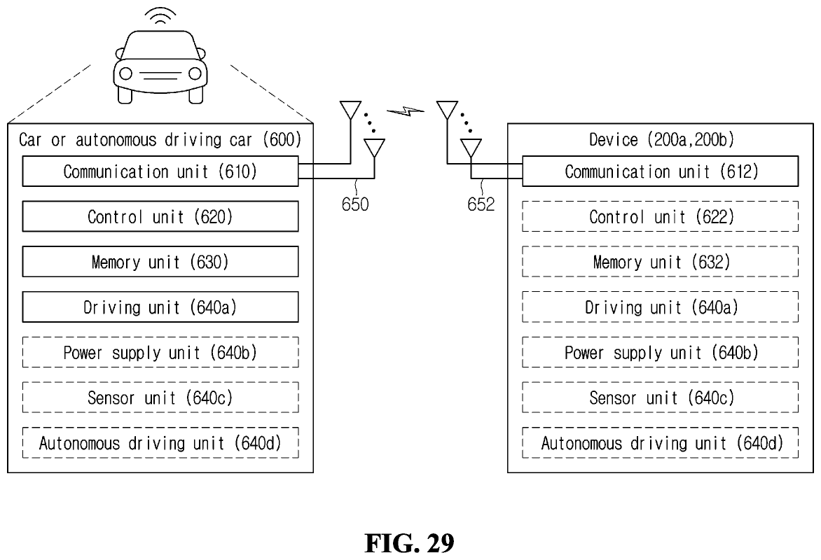

FIG. 29 illustrates a car or an autonomous vehicle, in accordance with an embodiment of the present disclosure. FIG. 29 exemplifies a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited. The embodiment of FIG. 29 may be combined with various embodiments of the present disclosure

Referring to FIG. 29, the car or autonomous driving car 600 may include an antenna unit (antenna) 608, a communication unit (transceiver) 610, a control unit (controller) 620, a driving unit 640a, a power supply unit (power supply) 640b, a sensor unit 640c, and an autonomous driving unit 640d. The antenna unit 650 may be configured as part of the communication unit 610. The blocks 610/630/640a to 640d correspond to the blocks 510/530/540 of FIG. 28, and duplicate descriptions are omitted.

The communication unit 610 may transmit and receive signals (e.g., data, control signals, etc.) to and from external devices such as another vehicle, a base station (e.g., a base station, a road side unit, etc.), and a server. The control unit 620 may control the elements of the car or autonomous driving car 600 to perform various operations. The control unit 620 may include an electronic control unit (ECU). The driving unit 640a may drive the car or autonomous driving car 600 on the ground. The driving unit 640a may include an engine, a motor, a power train, wheels, a brake, a steering device, etc. The power supply unit 640b may supply power to the car or autonomous driving car 600, and include a wired/wireless charging circuit, a battery, etc. The sensor unit 640c may obtain a vehicle state, surrounding environment information, user information, etc. The sensor unit 640c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 640d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 610 may receive map data, traffic information data, etc. from an external server. The autonomous driving unit 640d may generate an autonomous driving route and a driving plan based on the acquired data. The control unit 620 may control the driving unit 640a (e.g., speed/direction control) such that the car or autonomous driving car 600 moves along the autonomous driving route according to the driving plane. During autonomous driving, the communication unit 610 may aperiodically/periodically acquire latest traffic information data from an external server and acquire surrounding traffic information data from neighboring cars. In addition, during autonomous driving, the sensor unit 640c may acquire a vehicle state and surrounding environment information. The autonomous driving unit 640d may update the autonomous driving route and the driving plan based on newly acquired data/information. The communication unit 610 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1-20. (canceled)

21. A method of operating a first terminal in a wireless communication system, the method comprising:
transmitting at least one synchronization signal and first messages;
receiving, from a second terminal, which has received a first message of the first messages, an ACK of acknowledges (ACKs) transmitted through a resource associated with the first message; and
transmitting a second message,
wherein the at least one synchronization signal and the first messages are transmitted by using at least one transmit spatial domain filter, and
wherein the second message includes information related to the ACK and transmitted by using a first transmit spatial domain filter used to transmit the first message.

22. The method of claim 21, wherein the transmitting the at least one synchronization signal and the first messages comprises,
transmitting synchronization signals using a plurality of transmit spatial domain filters; and
transmitting the first messages using the plurality of transmit spatial domain filters.

23. The method of claim 21, further comprising:
confirming a second transmit spatial domain filter which is one of transmit spatial domain filters of the second terminal based on the resource in which the ACK is received.

24. The method of claim 21, wherein the second message comprises a media access control (MAC) control element (CE) including an index of a second transmit spatial domain filter of the second terminal used to transmit the ACK.

25. The method of claim 21, wherein the second message comprises a message requesting communication in a unicast mode.

26. The method of claim 21, wherein the transmitting the at least one synchronization signal and the first messages comprises,
transmitting one synchronization signal using the first transmit spatial domain filter among a plurality of transmit spatial domain filters; and
repeatedly transmitting the first messages using the first transmit spatial domain filter.

27. The method of claim 26, wherein the receiving one of the ACKs comprises attempting to receive the ACKs using a receive spatial domain filter corresponding to the first transmit spatial domain filter.

28. The method of claim 27, wherein a spatial domain filter width of the receive spatial domain filter is wider than that of the first transmit spatial domain filter.

29. The method of claim 27, further comprising:
receiving ACK responsive to the second message using a receive spatial domain filter corresponding to the first transmit spatial domain filter.

30. A first terminal in a wireless communication system, the first terminal comprising:
a transceiver; and
a processor coupled to the transceiver and configured to:
transmit at least one synchronization signal and first messages;
receive, from a second terminal, which has received a first message of the first messages, an ACK of acknowledges (ACKs) transmitted through a resource associated with the first message; and
transmit a second message,
wherein the at least one synchronization signal and the first messages are transmitted by using at least one transmit spatial domain filter, and
wherein the second message includes information related to the ACK and transmitted by using a first transmit spatial domain filter used to transmit the first message.

31. A second terminal in a wireless communication system, the second terminal comprising:
a transceiver; and
a processor coupled to the transceiver and configured to:
receive a synchronization signal transmitted by a first terminal using a first transmit spatial domain filter which is one of a plurality of transmit spatial domain filters;
receive a first message transmitted using the first transmit spatial domain filter;
transmit acknowledges (ACKs) responsive to the first message using a plurality of transmit spatial domain filters through a resource associated with the first message; and
receive a second message comprising information related to an ACK of the ACKs.

32. The second terminal of claim 31, wherein the processor is further configured to:
perform spatial domain filter sweeping using a plurality of receive spatial domain filters in order to receive the first message.

33. The second terminal of claim 31, wherein the plurality of transmit spatial domain filters used to transmit the ACKs comprises transmit spatial domain filters corresponding to a receive spatial domain filter of the second terminal used to receive the first message.

34. The second terminal of claim 31, wherein the processor is further configured to:
receive the second message using the receive spatial domain filter of the second terminal used to receive the first message.

35. The second terminal of claim 31, wherein the processor is further configured to:
transmit ACK responsive to the second message using a second transmit spatial domain filter used to transmit ACK indicated by the second message.

36. The second terminal of claim 31, wherein the processor is further configured to:
receive broadcast information indicating whether to support a spatial domain filter discovery procedure using the first message.

37. The second terminal of claim 31, wherein, in case that a plurality of first messages is received, ACK is not transmitted responsive to at least one first message other than the first message with the best reception quality among the received first messages.
